(19) United States
(12) Patent Application Publication
(10) Pub. No.: US 2025/0105364 A1
(43) Pub. Date: Mar. 27, 2025

(54) SECONDARY BATTERY AND BATTERY PACK

(71) Applicant: MURATA MANUFACTURING CO., LTD., Kyoto (JP)

(72) Inventors: Yosuke KAIHARA, Kyoto (JP); Toshikazu NAKAMURA, Kyoto (JP); Yukihiro OKAMOTO, Kyoto (JP); Kei WAKABAYASHI, Kyoto (JP)

(21) Appl. No.: 18/885,303

(22) Filed: Sep. 13, 2024

(30) Foreign Application Priority Data
Sep. 27, 2023 (JP) 2023-165909

(51) Int. Cl. H01M 10/0587; H01M 4/02; H01M 50/107

(52) U.S. Cl. CPC H01M 10/0587; H01M 50/107; H01M 2004/028

(57) ABSTRACT

A secondary battery includes an electrode wound body. The electrode wound body includes a stacked body including a positive electrode, a negative electrode, and a separator and wound along a longitudinal direction thereof, and has a through hole in a width direction. The positive electrode includes a positive electrode active material layer, and a positive electrode current collector including a positive electrode covered region and a positive electrode exposed region. The positive electrode covered region is covered with the positive electrode active material layer. The positive electrode exposed region is covered with no positive electrode active material layer and extends in the width direction from the positive electrode active material layer. The positive electrode active material layer includes a first thin part, and a first thick part having a thickness greater than that of the first thin part and being adjacent to the first thin part in the width direction.

### CROSS-REFERENCE TO RELATED APPLICATIONS

The present application claims priority from Japanese Patent Application No. 2023-165909, filed on Sep. 27, 2023, the entire contents of which are hereby incorporated by reference.

### BACKGROUND

The present disclosure relates to a secondary battery, and to a battery pack that includes the secondary battery.

Various kinds of electronic equipment, including mobile phones, have been widely used. Such widespread use has promoted development of a secondary battery as a power source that is smaller in size and lighter in weight and allows for a higher energy density. The secondary battery includes a battery device contained inside an outer package member. A configuration of the secondary battery has been considered in various ways.

For example, a secondary battery is disclosed in which what is called a tabless structure is employed. Such a secondary battery achieves a reduced internal resistance and allows for charging and discharging with a relatively large current.

### SUMMARY

A secondary battery according to an embodiment of the present disclosure includes an electrode wound body and an outer package can. The electrode wound body includes a stacked body and has a through hole.

The stacked body includes a positive electrode, a negative electrode, and a separator and is wound along a longitudinal direction of the stacked body. The through hole is provided through the electrode wound body in a width direction orthogonal to the longitudinal direction. The outer package can contains the electrode wound body. The positive electrode includes a positive electrode active material layer and a positive electrode current collector. The positive electrode active material layer extends in both the longitudinal direction and the width direction. The positive electrode current collector includes a positive electrode covered region and a positive electrode exposed region.

The positive electrode covered region is covered with the positive electrode active material layer. The positive electrode exposed region is covered with no positive electrode active material layer and extends in the width direction from the positive electrode active material layer. The positive electrode active material layer includes a first thin part and a first thick part. The first thick part has a thickness greater than a thickness of the first thin part and is adjacent to the first thin part in the width direction.

A battery pack according to an embodiment of the present disclosure includes a secondary battery, a processor, and an outer package body. The processor is configured to control the secondary battery. The outer package body contains the secondary battery. The secondary battery includes an electrode wound body and an outer package can. The electrode wound body includes a stacked body and has a through hole. The stacked body includes a positive electrode, a negative electrode, and a separator and is wound along a longitudinal direction of the stacked body. The through hole is provided through the electrode wound body in a width direction orthogonal to the longitudinal direction. The outer package can contains the electrode wound body. The positive electrode includes a positive electrode active material layer and a positive electrode current collector. The positive electrode active material layer extends in both the longitudinal direction and the width direction. The positive electrode current collector includes a positive electrode covered region and a positive electrode exposed region. The positive electrode covered region is covered with the positive electrode active material layer. The positive electrode exposed region is covered with no positive electrode active material layer and extends in the width direction from the positive electrode active material layer. The positive electrode active material layer includes a first thin part and a first thick part. The first thick part has a thickness greater than a thickness of the first thin part and is adjacent to the first thin part in the width direction.

### BRIEF DESCRIPTION OF THE FIGURES

The accompanying drawings are included to provide a further understanding of the present disclosure and are incorporated in and constitute a part of this specification. The drawings illustrate example embodiments and, together with the specification, serve to explain the principles of the present disclosure.

FIG. 1 is a sectional diagram illustrating a configuration example of a vertical sectional structure, along a height direction, of a secondary battery according to an embodiment of the present disclosure.

FIG. 2 is a horizontal sectional diagram illustrating a configuration example of an electrode wound body of the secondary battery illustrated in FIG. 1.

FIG. 3 is a sectional diagram illustrating a configuration example of the electrode wound body illustrated in FIG. 2 in an unwound state.

FIG. 4A is a plan diagram illustrating a configuration example of a positive electrode when the electrode wound body illustrated in FIG. 2 is in the unwound state.

FIG. 4B is a plan diagram illustrating a configuration example of a negative electrode when the electrode wound body illustrated in FIG. 2 is in the unwound state.

FIG. 5A is a first sectional view of the positive electrode illustrated in FIG. 4A.

FIG. 5B is a second sectional view of the positive electrode illustrated in FIG. 4A.

FIG. 6 is a block diagram illustrating a circuit configuration of a battery pack to which the secondary battery according to an embodiment of the present disclosure is applied.

FIG. 7 is a sectional view of a positive electrode according to a first modification example of an embodiment of the present disclosure.

FIG. 8A is a sectional diagram illustrating a first example of a positive electrode according to a second modification example of an embodiment of the present disclosure.

FIG. 8B is a sectional diagram illustrating a second example of the positive electrode according to the second modification example of an embodiment of the present disclosure.

FIG. 8C is a sectional diagram illustrating a third example of the positive electrode according to the second modification example of an embodiment of the present disclosure.

FIG. 9A is a plan diagram illustrating a positive electrode according to a third modification example of an embodiment of the present disclosure.

FIG. 9B is a sectional view of the positive electrode illustrated in FIG. 9A.

FIG. 10A is a plan diagram illustrating a positive electrode of Example 1-2.

FIG. 10B is a sectional view of the positive electrode of Example 1-2.

FIG. 11A is a plan diagram illustrating a positive electrode of Example 1-3.

FIG. 11B is a sectional view of the positive electrode of Example 1-3.

FIG. 12 is a sectional view of a positive electrode of Example 3-1.

### DETAILED DESCRIPTION

Consideration has been given in various ways to improve performance of a secondary battery. However, there is still room for improvement in reliability of the secondary battery.

It is desirable to provide a secondary battery that is superior in reliability, and to provide a battery pack that includes such a secondary battery.

In the following, the present disclosure is described in further detail including with reference to the accompanying drawings according to an embodiment. Note that the following description is directed to illustrative examples of the present disclosure and not to be construed as limiting to the present disclosure. Factors including, without limitation, numerical values, shapes, materials, components, positions of the components, and how the components are coupled to each other are illustrative only and not to be construed as limiting to the present disclosure. Further, elements in the following example embodiments which are not recited in a most-generic independent claim of the present disclosure are optional and may be provided on an as-needed basis. The drawings are schematic and are not intended to be drawn to scale. Throughout the present specification and the drawings, elements having substantially the same function and configuration are denoted with the same reference numerals to avoid any redundant description. In addition, elements that are not directly related to any embodiment of the present disclosure are unillustrated in the drawings.

First, a description is given of a secondary battery according to an embodiment of the present disclosure.

Although a charge and discharge principle of the secondary battery described herein is not particularly limited, the following description deals with a case where a battery capacity is obtained through insertion and extraction of an electrode reactant.

The secondary battery may include a positive electrode, a negative electrode, and an electrolyte. In the secondary battery, a charge capacity of the negative electrode may be greater than a discharge capacity of the positive electrode. For example, an electrochemical capacity per unit area of the negative electrode may be set to be greater than an electrochemical capacity per unit area of the positive electrode. One reason for this is to prevent precipitation of the electrode reactant on a surface of the negative electrode during charging.

Although not particularly limited in kind, the electrode reactant may be, for example, a light metal such as an alkali metal or an alkaline earth metal. Non-limiting examples of the alkali metal may include lithium, sodium, and potassium. Non-limiting examples of the alkaline earth metal may include beryllium, magnesium, and calcium.

In the following, described as an example is a case where the electrode reactant is lithium. A secondary battery in which the battery capacity is obtained through insertion and extraction of lithium may be what is called a lithium-ion secondary battery. In the lithium-ion secondary battery, lithium may be inserted and extracted in an ionic state.

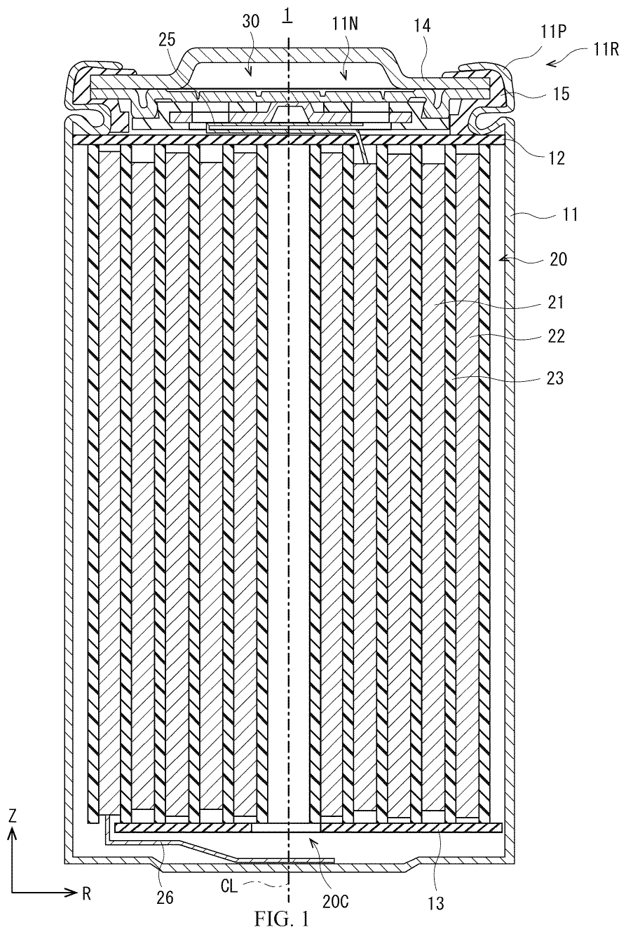

FIG. 1 illustrates a sectional configuration of the secondary battery 1 according to an embodiment. As illustrated in FIG. 1, the secondary battery 1 may be what is called a cylindrical secondary battery in which an electrode wound body 20 as a battery device is contained inside a battery can 11 having a cylindrical shape. A reference sign CL denotes a central axis of the secondary battery 1.

Hereinafter, a direction in which the electrode wound body 20 is placed into the battery can 11, for example, a height direction of the battery can 11 having the cylindrical shape, is referred to as a Z direction; and a radial direction of the battery can 11 having the cylindrical shape is referred to as an R direction.

For example, in the secondary battery 1 illustrated in FIG. 1, a pair of insulating plates 12 and 13 and the electrode wound body 20 may be contained inside the battery can 11 having the cylindrical shape. The electrode wound body 20 may be interposed between the insulating plate 12 and the insulating plate 13 in the Z direction. A safety valve mechanism 30 may be attached to the battery can 11. The battery can 11 may be, for example, sealed by a battery cover 14. In an embodiment, the secondary battery 1 may further include components including, without limitation, a thermosensitive resistive device and a reinforcing member inside the battery can 11. Non-limiting examples of the thermosensitive resistive device may include a positive temperature coefficient (PTC) device.

The battery can 11 may correspond to a specific but non-limiting example of an “outer package can” in an embodiment of the present disclosure.

The battery can 11 may be a container having a hollow structure that extends in the Z direction, with one end part in the Z direction closed and another end part in the Z direction open. The one end part of the battery can 11 in the Z direction may be an open end part 11N. The battery can 11 may include, for example, any one or more of metal materials including, without limitation, iron, aluminum, and alloys thereof. In an embodiment, the battery can 11 may have a surface plated with, for example, any one or more of metal materials including, without limitation, nickel.

The pair of insulating plates 12 and 13 may be disposed with the electrode wound body 20 interposed therebetween in the Z direction and extend along a plane orthogonal to the Z direction.

The battery cover 14 and the safety valve mechanism 30 may be crimped at the open end part 11N of the battery can 11 with a gasket 15 interposed between the open end part 11N and both the battery cover 14 and the safety valve mechanism 30. The battery can 11 may thus be provided with a bent part 11P defining the open end part 11N.

The open end part 11N of the battery can 11 may be sealed by the battery cover 14 in a state where the electrode wound body 20 and other components are contained inside the battery can 11. The battery can 11 may have a crimped structure 11R provided in the vicinity of the open end part 11N. The crimped structure 11R may be a structure in which the bent part 11P defining the open end part 11N and both the battery cover 14 and the safety valve mechanism 30 are crimped to each other with the gasket 15 interposed therebetween. The bent part 11P may be what is called a crimped part.

The battery cover 14 may be a cover member that closes the open end part 11N of the battery can 11. In an embodiment, the battery cover 14 may include a material similar to the material included in the battery can 11. However, in an embodiment, the battery cover 14 may include a material different from the material included in the battery can 11

In an embodiment, the battery cover 14 may include stainless steel. One reason for this is that this secures physical strength of the battery cover 14 and accordingly secures physical strength of the crimped structure 11R, which helps to suppress detachment of the battery cover 14 and leakage of an electrolytic solution even if an internal pressure of the battery can 11 increases. Non-limiting examples of the stainless steel may include SUS304 and SUS430.

A middle part of the battery cover 14 may be bent to protrude in a direction away from the electrode wound body 20, i.e., in a +Z direction.

The gasket 15 may be a sealing member that seals a gap between the bent part 11P and the battery cover 14. The gasket 15 may be interposed between the bent part 11P of the battery can 11 and the battery cover 14.

The gasket 15 may include any one or more of insulating materials. Non-limiting examples of the insulating materials may include a polymer material such as polybutylene terephthalate (PBT) or polypropylene (PP). In an embodiment, the gasket 15 may include polypropylene. One reason for this is that this helps to allow for sufficient sealing of the gap between the bent part 11P and the battery cover 14, with the battery can 11 and the battery cover 14 being electrically separated from each other.

The safety valve mechanism 30 may be provided on an inner side of the battery cover 14 in the Z direction. The safety valve mechanism 30 may be a mechanism that, when the internal pressure of the battery can 11 increases, releases the internal pressure by unsealing the battery can 11 on an as-needed basis. Non-limiting examples of a cause of the increase in the internal pressure of the battery can 11 may include a gas generated due to a decomposition reaction of the electrolytic solution upon charging and discharging.

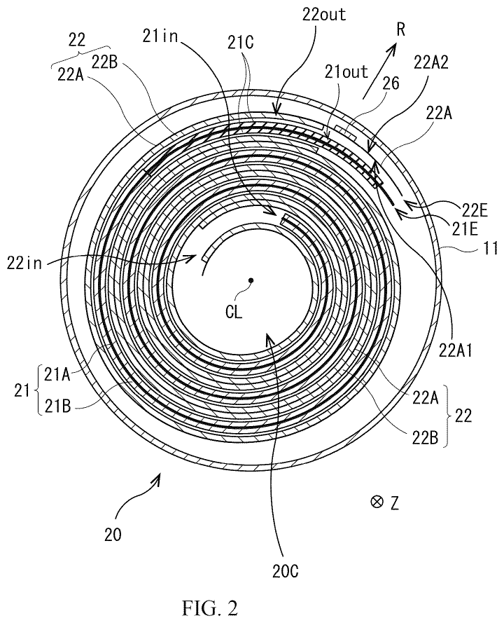

FIG. 2 is a horizontal sectional diagram illustrating a configuration example of the electrode wound body 20 along a section orthogonal to the Z direction. Note that FIG. 2 also illustrates the battery can 11. The electrode wound body 20 is contained inside the battery can 11. The electrode wound body 20 may include a positive electrode 21, a negative electrode 22, and an electrolytic solution. The electrolytic solution may be a liquid electrolyte. The electrode wound body 20 may further include a positive electrode lead 25 and a negative electrode lead 26 as illustrated in FIG. 1.

The electrode wound body 20 may be a stacked body S20 in a wound state. The stacked body S20 may include the positive electrode 21 and the negative electrode 22 that are stacked with a separator 23 interposed therebetween. For example, as illustrated in FIG. 2, the electrode wound body 20 may be the stacked body S20 so wound around the central axis CL extending in the Z direction as to form a spiral shape in a horizontal section orthogonal to the Z direction. The electrode wound body 20 may have an outer appearance of a substantially circular columnar shape as a whole. The positive electrode 21 and the negative electrode 22 may be wound, remaining in a state of being opposed to each other with the separator 23 interposed therebetween. The positive electrode 21, the negative electrode 22, and the separator 23 may each be impregnated with the electrolytic solution. Note that, FIG. 2 omits illustration of the separator 23 and the positive electrode lead 25.

The electrode wound body 20 may have, at the center thereof, a space resulting from winding the positive electrode 21, the negative electrode 22, and the separator 23, i.e., a through hole 20C.

The positive electrode 21, the negative electrode 22, and the separator 23 may be so wound that the separator 23 is positioned in each of an outermost wind of the electrode wound body 20 and an innermost wind of the electrode wound body 20. In the outermost wind of the electrode wound body 20, the negative electrode 22 may be positioned on an outer side relative to the positive electrode 21. For example, as illustrated in FIG. 2, an outermost wind part 21out of the positive electrode 21 positioned in an outermost wind of the positive electrode 21 included in the electrode wound body 20 may be positioned on an inner side relative to an outermost wind part 22out of the negative electrode 22 positioned in an outermost wind of the negative electrode 22 included in the electrode wound body 20. Here, the outermost wind part 21out of the positive electrode 21 may be a part corresponding to the outermost one wind of the positive electrode 21 in the electrode wound body 20. The outermost wind part 22out of the negative electrode 22 may be a part corresponding to the outermost one wind of the negative electrode 22 in the electrode wound body 20. In contrast, in the innermost wind of the electrode wound body 20, the negative electrode 22 may be positioned on the inner side relative to the positive electrode 21. For example, as illustrated in FIG. 2, an innermost wind part 22 in of the negative electrode 22 positioned in an innermost wind of the negative electrode 22 included in the electrode wound body 20 may be positioned on the inner side relative to an innermost wind part 21in of the positive electrode 21 positioned in an innermost wind of the positive electrode 21 included in the electrode wound body 20. Here, the innermost wind part 21in of the positive electrode 21 may be a part corresponding to the innermost one wind of the positive electrode 21 in the electrode wound body 20. The innermost wind part 22 in of the negative electrode 22 may be a part corresponding to the innermost one wind of the negative electrode 22 in the electrode wound body 20. The number of winds of each of the positive electrode 21, the negative electrode 22, and the separator 23 is not particularly limited, and may be set as desired.

The positive electrode lead 25 may be coupled to the positive electrode 21. The negative electrode lead 26 may be coupled to the negative electrode 22. The positive electrode lead 25 may include any one or more of electrically conductive materials including, without limitation, a metal material. Non-limiting examples of the metal material included in the positive electrode lead 25 may include aluminum. The positive electrode lead 25 may be electrically coupled to the battery cover 14 via the safety valve mechanism 30. The negative electrode lead 26 may include any one or more of electrically conductive materials including, without limitation, a metal material. Non-limiting examples of the metal material included in the negative electrode lead 26 may include nickel. The negative electrode lead 26 may be electrically coupled to the battery can 11. An example detailed configuration of the electrode wound body 20, i.e., an example detailed configuration of each of the positive electrode 21, the negative electrode 22, the separator 23, and the electrolytic solution will be described below.

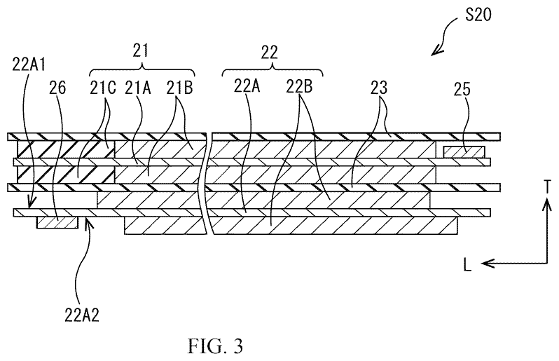

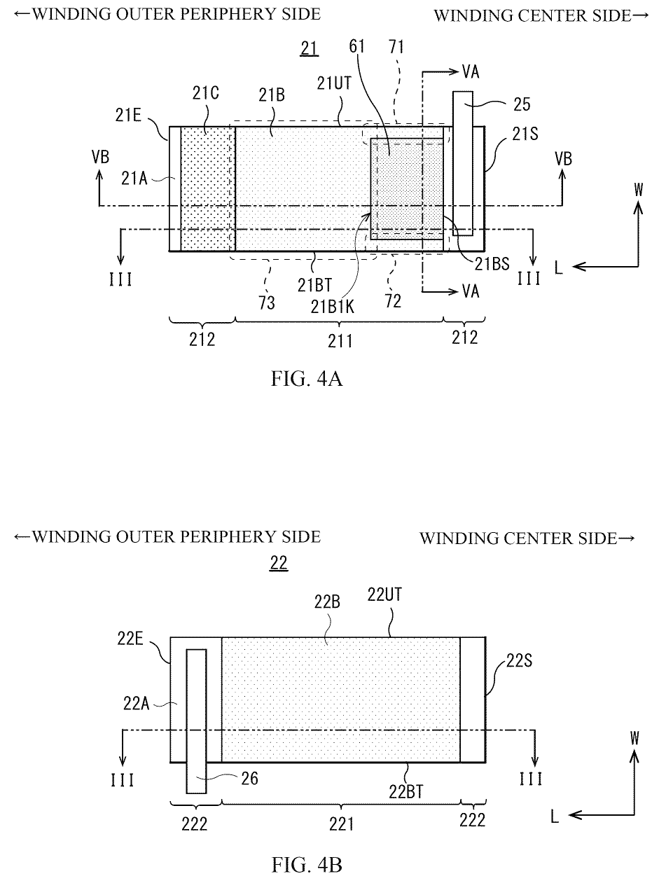

FIG. 3 illustrates a sectional configuration of the stacked body S20 corresponding to the electrode wound body 20 in an unwound state. FIG. 4A is a plan diagram illustrating a configuration example of the positive electrode 21 when the electrode wound body 20 is in the unwound state. FIG. 4B is a plan diagram illustrating a configuration example of the negative electrode 22 when the electrode wound body 20 illustrated in FIG. 2 is in the unwound state. Note that FIG. 3 illustrates a section as viewed in an arrowed direction along line III-III illustrated in each of FIG. 4A and FIG. 4B. As illustrated in FIG. 3, the positive electrode 21, the separator 23, the negative electrode 22, and the separator 23 may be stacked in a T direction. The T direction corresponds to the R direction that is a radial direction of the electrode wound body 20 and the radial direction of the battery can 11.

As illustrated in FIGS. 2, 3, and 4A, the positive electrode 21 includes a positive electrode current collector 21A and a positive electrode active material layer 21B. The positive electrode 21 may further include a protective tape 21C.

The positive electrode current collector 21A may have two opposite surfaces on each of which the positive electrode active material layer 21B is to be provided. The positive electrode current collector 21A may include an electrically conductive material such as metal material. The positive electrode current collector 21A may be a metal foil including aluminum or an aluminum alloy, for example.

In an embodiment illustrated in FIGS. 2 and 3, the positive electrode active material layer 21B may be provided on each of the two opposite surfaces of the positive electrode current collector 21A. The positive electrode active material layer 21B may include any one or more of positive electrode active materials into which lithium is insertable and from which lithium is extractable. Note that, in an embodiment, the positive electrode active material layer 21B may be provided simply on one of the two opposite surfaces of the positive electrode current collector 21A, on a side on which the positive electrode 21 is opposed to the negative electrode 22. In an embodiment, the positive electrode active material layer 21B may further include materials including, without limitation, a positive electrode binder and a positive electrode conductor. A method of forming the positive electrode active material layer 21B is not particularly limited, and may be, for example, a method such as a coating method.

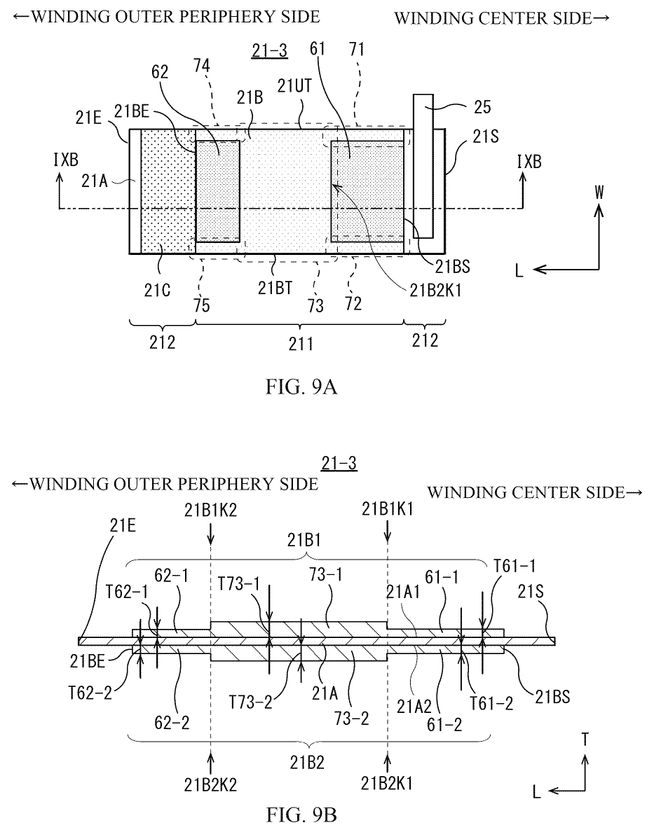

The positive electrode active material layer 21B may cover a portion of the corresponding surface of the positive electrode current collector 21A. The positive electrode 21 may include a positive electrode covered region 211 and a positive electrode exposed region 212. The positive electrode covered region 211 may be a region of the positive electrode 21 in which the positive electrode current collector 21A is covered with the positive electrode active material layer 21B. The positive electrode exposed region 212 may be a region of the positive electrode 21 other than the positive electrode covered region 211. In other words, the positive electrode exposed region 212 may be a region in which the positive electrode current collector 21A is not covered with the positive electrode active material layer 21B and is exposed. As illustrated in FIG. 4A, the positive electrode covered region 211 and the positive electrode exposed region 212 may each extend along a W direction, i.e., a transverse direction of the positive electrode 21, from an upper edge 21UT of the positive electrode 21 to a lower edge 21BT of the positive electrode 21. The positive electrode exposed region 212 extends in the W direction from the positive electrode active material layer 21B. In an embodiment, the positive electrode exposed region 212 may extend in a direction different from the W direction, e.g., in a longitudinal direction from the positive electrode active material layer 21B. Two positive electrode exposed regions 212 may be provided at respective end parts of the positive electrode 21 in an L direction corresponding to a longitudinal direction of the positive electrode 21. Here, the L direction corresponds to a winding direction of the electrode wound body 20. One of the two positive electrode exposed regions 212 may include an inner winding side edge 21S of the innermost wind part 21in of the positive electrode 21, and another of the two positive electrode exposed regions 212 may include an outer winding side edge 21E of the outermost wind part 21out of the positive electrode 21. For the innermost wind part 21in and the outermost wind part 21out, refer to FIG. 2. The positive electrode covered region 211 may be interposed between the two positive electrode exposed regions 212 in the L direction. In other words, the positive electrode active material layers 21B may be absent at each of opposite end parts of the positive electrode current collector 21A in the L direction, i.e., the longitudinal direction of the positive electrode current collector 21A. The protective tape 21C may be provided on a portion of the positive electrode exposed region 212. For example, the protective tape 21C may cover a portion, of the positive electrode current collector 21A in the positive electrode exposed region 212, that is opposed to a negative electrode active material layer 22B. The negative electrode active material layer 22B will be described later. In an embodiment, the protective tape 21C may cover a portion of any of a thick part 73 and thick parts 74 and 75, which will be described later with reference to FIG. 9A. Note that in the configuration example illustrated in FIG. 4A, the protective tape 21C may be provided on the positive electrode exposed region 212 on a winding outer periphery side, of the two positive electrode exposed regions 212; however, this is non-limiting. In an embodiment, the protective tape 21C may be provided also on the positive electrode exposed region 212 on a winding center side, of the two positive electrode exposed regions 212. The positive electrode lead 25 may be attached to the positive electrode current collector 21A in the positive electrode exposed region 212 on the winding center side.

The positive electrode active material may include a lithium compound. The lithium compound may be a compound including lithium as a constituent element, and may be, for example, a compound including lithium and one or more transition metal elements as constituent elements. One reason for this is that this helps to obtain a high energy density. Note that, in an embodiment, the lithium compound may further include any one or more of other elements, i.e., elements other than lithium and the transition metal elements.

The lithium compound is not limited to a particular kind, and non-limiting examples thereof may include a lithium composite oxide having a layered rock-salt crystal structure, a lithium composite oxide having a spinel crystal structure, and a lithium phosphoric acid compound having an olivine crystal structure. Non-limiting examples of the lithium composite oxide having the layered rock-salt crystal structure may include LiNiO₂, LiN_{0.8}Co_{0.15}Al_{0.05}, and LiCoO₂. Non-limiting examples of the lithium composite oxide having the spinel crystal structure may include LiMn₂O₄. Non-limiting examples of the lithium phosphoric acid compound having the olivine crystal structure may include LiFePO₄ and LiMnPO₄.

In an embodiment, the positive electrode active material may include the lithium phosphoric acid compound having the olivine crystal structure. One reason for this is that, because the crystal structure of the lithium phosphoric acid compound having the olivine crystal structure is thermally stable, this helps to prevent the secondary battery 1 from easily exhibiting thermal runaway due to a cause such as overcharging or an internal short circuit. Another reason is that, because the crystal structure of the lithium phosphoric acid compound having the olivine crystal structure is firm, this helps to prevent the battery capacity from decreasing easily even if the secondary battery 1 is charged and discharged repeatedly.

The positive electrode binder may include any one or more of materials including, without limitation, a synthetic rubber and a polymer compound. Non-limiting examples of the synthetic rubber may include a styrene-butadiene-based rubber. Non-limiting examples of the polymer compound may include polyvinylidene difluoride.

The positive electrode conductor may include any one or more of electrically conductive materials including, without limitation, a carbon material. Non-limiting examples of the carbon material may include graphite, carbon black, acetylene black, and Ketjen black. Note that, in an embodiment, the electrically conductive material may be a metal material or a polymer compound, for example.

In an embodiment, the protective tape 21C may be adhered to the separator 23. One reason for this is that this helps to prevent the positive electrode 21 and the separator 23 from becoming misaligned with each other. In an embodiment, the protective tape 21C may include a material that does not swell easily. One reason for this is that this helps to prevent the negative electrode from being damaged due to swelling of the protective tape 21C. In an embodiment, the protective tape 21C may include a resin including polyimide (PI), for example.

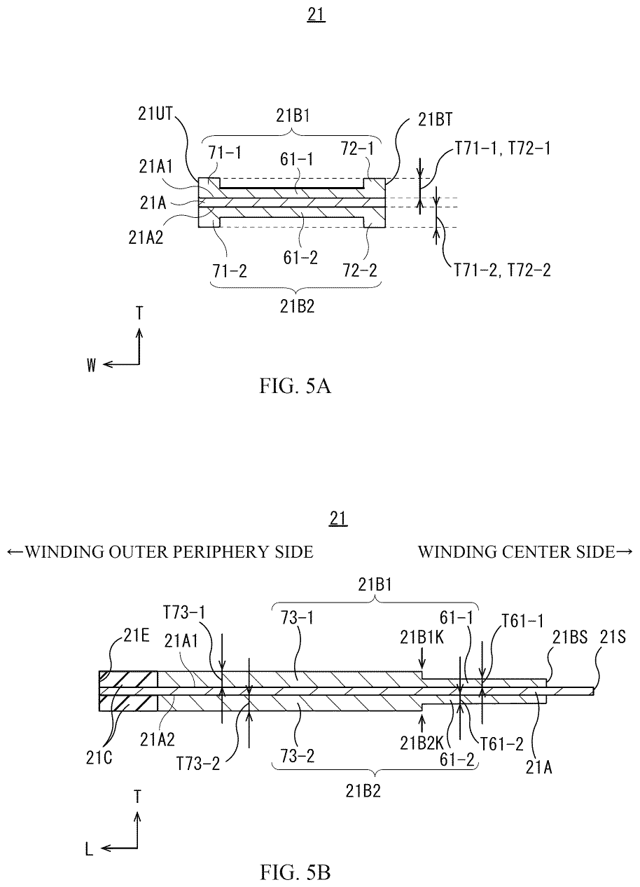

FIGS. 5A and 5B each illustrate a sectional configuration of the positive electrode 21. FIG. 5A illustrates a section as viewed in an arrowed direction along line VA-VA illustrated in FIG. 4A. FIG. 5B illustrates a section as viewed in an arrowed direction along line VB-VB illustrated in FIG. 4A. FIGS. 5A and 5B each illustrate a case where the positive electrode active material layer 21B is provided on each of the two opposite surfaces of the positive electrode current collector 21A. In an embodiment, the positive electrode current collector 21A may include an inward surface 21A1 facing toward the central axis CL and an outward surface 21A2 positioned on an opposite side of the positive electrode current collector 21A to the inward surface 21A1. In an embodiment, the positive electrode 21 may include an inner winding side positive electrode active material layer 21B1 and an outer winding side positive electrode active material layer 21B2, as the positive electrode active material layers 21B. The inner winding side positive electrode active material layer 21B1 may cover all or a part of the inward surface 21A1 of the positive electrode current collector 21A. The outer winding side positive electrode active material layer 21B2 may cover all or a part of the outward surface 21A2 of the positive electrode current collector 21A. Herein, the inner winding side positive electrode active material layer 21B1 and the outer winding side positive electrode active material layer 21B2 may each be generically referred to as the positive electrode active material layer 21B, without being distinguished from each other. The positive electrode active material layer 21B may extend in both the L direction and the W direction orthogonal to the L direction. The L direction corresponds to a winding direction of the stacked body S20. The W direction substantially coincides with the central axis CL. The inner winding side positive electrode active material layer 21B1 may correspond to a specific but non-limiting example of a “first positive electrode active material layer” in an embodiment of the present disclosure. The outer winding side positive electrode active material layer 21B2 may correspond to a specific but non-limiting example of a “second positive electrode active material layer” in an embodiment of the present disclosure.

The positive electrode current collector 21A may include the positive electrode covered region 211 and the positive electrode exposed region 212 as described above. The positive electrode covered region 211 may be covered with the positive electrode active material layer 21B. The positive electrode exposed region 212 may not be covered with the positive electrode active material layer 21B. The positive electrode active material layer 21B includes a thin part 61 and a thick part 71. In an embodiment, the positive electrode active material layer 21B may further include a thick part 72 and the thick part 73. In the positive electrode 21 of an embodiment, each of the thin part 61 and the thick parts 71 to 73 may be provided on each of the inward surface 21A1 and the outward surface 21A2 of the positive electrode current collector 21A. In other words, each of the inner winding side positive electrode active material layer 21B1 and the outer winding side positive electrode active material layer 21B2 may include each of the thin part 61 and the thick parts 71 to 73. In an embodiment, however, in the positive electrode 21, at least either the inner winding side positive electrode active material layer 21B1 or the outer winding side positive electrode active material layer 21B2 may include the thin part 61 and the thick parts 71 to 73. Note that, for convenience, in FIGS. 5A and 5B, the thin part 61 and the thick parts 71, 72, and 73 included in the inner winding side positive electrode active material layer 21B1 are respectively denoted as a thin part 61-1 and thick parts 71-1, 72-1, and 73-1. The thin part 61 and the thick parts 71, 72, and 73 included in the outer winding side positive electrode active material layer 21B2 are respectively denoted as a thin part 61-2 and thick parts 71-2, 72-2, and 73-2. Further, in an embodiment illustrated in FIG. 5B, a position of a border 21B1K between the thin part 61-1 and the thick part 73-1 in the L direction may substantially coincide with a position of a border 21B2K between the thin part 61-2 and the thick part 73-2 in the L direction. The thin part 61 may correspond to a specific but non-limiting example of a “first thin part” in an embodiment of the present disclosure. The thick part 71 may correspond to a specific but non-limiting example of a “first thick part” in an embodiment of the present disclosure. The thick part 72 may correspond to a specific but non-limiting example of a “second thick part” in an embodiment of the present disclosure. The thick part 73 may correspond to a specific but non-limiting example of a “third thick part” in an embodiment of the present disclosure. The border 21B1K may correspond to a specific but non-limiting example of a “first border” in an embodiment of the present disclosure. The border 21B2K may correspond to a specific but non-limiting example of a “second border” in an embodiment of the present disclosure.

The thick part 71 has a thickness greater than a thickness of the thin part 61. Each of the thick parts 72 and 73 may have a thickness greater than the thickness of the thin part 61. For example, the thickness of the thin part 61 may be about half the thickness of each of the thick parts 71 to 73. The respective thicknesses of the thick parts 71 to 73 may be equal to each other, or may be different from each other. For example, as illustrated in each of FIGS. 5A and 5B, in the inner winding side positive electrode active material layer 21B1, each of a thickness T71-1 of the thick part 71-1, a thickness T72-1 of the thick part 72-1, and a thickness T73-1 of the thick part 73-1 may be greater than a thickness T61-1 of the thin part 61-1. Note that in an embodiment illustrated in FIGS. 5A and 5B, the thickness T71-1 of the thick part 71-1, the thickness T72-1 of the thick part 72-1, and the thickness T73-1 of the thick part 73-1 may be equal to each other. Similarly, in the outer winding side positive electrode active material layer 21B2, each of a thickness T71-2 of the thick part 71-2, a thickness T72-2 of the thick part 72-2, and a thickness T73-2 of the thick part 73-2 may be greater than a thickness T61-2 of the thin part 61-2. Note that in an embodiment illustrated in FIGS. 5A and 5B, the thickness T71-2 of the thick part 71-2, the thickness T72-2 of the thick part 72-2, and the thickness T73-2 of the thick part 73-2 may be equal to each other. The thickness T61-1 and the thickness T61-2 may be equal to each other, or may be different from each other. The thickness T71-1 and the thickness T71-2 may be equal to each other, or may be different from each other. The thickness T72-1 and the thickness T72-2 may be equal to each other, or may be different from each other. The thickness T73-1 and the thickness T73-2 may be equal to each other, or may be different from each other.

In an embodiment, the thin part 61 may include a winding center side edge 21BS of the positive electrode active material layer 21B. The winding center side edge 21BS may be an edge of the positive electrode active material layer 21B on the winding center side in the L direction. In an embodiment, the thin part 61 may extend, in the L direction, for example, in a range of about one wind to about five winds of the electrode wound body 20 from the winding center side edge 21BS of the positive electrode active material layer 21B. The thick part 71 is adjacent to the thin part 61 in the W direction. For example, the thick part 71 may be positioned between the thin part 61 and the upper edge 21UT in the W direction. The thick part 72 may be positioned on an opposite side of the thin part 61 to the thick part 71 in the W direction. For example, the thick part 72 may be provided at a position between the lower edge 21BT and the thin part 61 in the W direction. The lower edge 21BT may be positioned on an opposite side to the upper edge 21UT in the W direction. The thick part 72 may include the lower edge 21BT. The thick part 73 may be positioned on an opposite side of the thin part 61 to the inner winding side edge 21S in the L direction. Note that, in an embodiment, the thick parts 71 to 73 may be separated from each other. In an embodiment, all or a part of the thick parts 71 to 73 may be integrated with each other.

The negative electrode 22 may include, as illustrated in FIGS. 2, 3, and 4B, a negative electrode current collector 22A and the negative electrode active material layer 22B.

The negative electrode current collector 22A may have two opposite surfaces on each of which the negative electrode active material layer 22B is to be provided. The negative electrode current collector 22A may include an electrically conductive material such as a metal material. The negative electrode current collector 22A may be a metal foil including a material such as nickel, a nickel alloy, copper, or a copper alloy.

In an embodiment illustrated in FIGS. 2 and 3, the negative electrode active material layer 22B may be provided on each of the two opposite surfaces of the negative electrode current collector 22A. The negative electrode active material layer 22B may include any one or more of negative electrode active materials into which lithium is insertable and from which lithium is extractable. Note that, in an embodiment, the negative electrode active material layer 22B may be provided simply on one of the two opposite surfaces of the negative electrode current collector 22A, on a side on which the negative electrode 22 is opposed to the positive electrode 21. In an embodiment, the negative electrode active material layer 22B may further include materials including, without limitation, a negative electrode binder and a negative electrode conductor. Details of the negative electrode binder may be similar to those of the positive electrode binder. Details of the negative electrode conductor may be similar to those of the positive electrode conductor. A method of forming the negative electrode active material layer 22B is not particularly limited, and may include, for example, any one or more of methods including, without limitation, a coating method, a vapor-phase method, a liquid-phase method, a thermal spraying method, and a firing or sintering method.

The negative electrode active material may include a carbon material, a metal-based material, or both, for example. One reason for this is that this helps to obtain a high energy density. Non-limiting examples of the carbon material may include graphitizable carbon, non-graphitizable carbon, and graphite such as natural graphite or artificial graphite. The metal-based material may be a material that includes, as one or more constituent elements, any one or more elements among metal elements and metalloid elements that are each able to form an alloy with lithium. Non-limiting examples of such metal elements and metalloid elements may include silicon, tin, or both. Note that, in an embodiment, the metal-based material may be a simple substance, an alloy, a compound, a mixture of two or more thereof, or a material including two or more phases thereof. Non-limiting examples of the metal-based material may include TiSi₂ and SiOₓ (0<x≤2 or 0.2<x<1.4).

The negative electrode current collector 22A may include two opposite surfaces, i.e., an inward surface 22A1 and an outward surface 22A2. The negative electrode active material layer 22B may cover a portion of each of the inward surface 22A1 and the outward surface 22A2 of the negative electrode current collector 22A. The negative electrode 22 may include a negative electrode covered region 221 and a negative electrode exposed region 222. The negative electrode covered region 221 may be a region of the negative electrode 22 in which the negative electrode current collector 22A is covered with the negative electrode active material layer 22B. The negative electrode exposed region 222 may be a region of the negative electrode 22 other than the negative electrode covered region 221. In other words, the negative electrode exposed region 222 may be a region in which the negative electrode current collector 22A is not covered with the negative electrode active material layer 22B and is exposed. As illustrated in FIG. 4B, the negative electrode covered region 221 and the negative electrode exposed region 222 may each extend along the W direction, i.e., a transverse direction of the negative electrode 22, from an upper edge 22UT of the negative electrode 22 to a lower edge 22BT of the negative electrode 22. Two negative electrode exposed regions 222 may be provided at respective end parts of the negative electrode 22 in the L direction corresponding to a longitudinal direction of the negative electrode 22. One of the two negative electrode exposed regions 222 may include an inner winding side edge 22S of the innermost wind part 22 in of the negative electrode 22, and another of the two negative electrode exposed regions 222 may include an outer winding side edge 22E of the outermost wind part 22out of the negative electrode 22. For the innermost wind part 22 in and the outermost wind part 22out, refer to FIG. 2. The negative electrode covered region 221 may be interposed between the two negative electrode exposed regions 222 in the L direction. In other words, the negative electrode active material layers 22B may be absent at each of opposite end parts of the negative electrode current collector 22A in the L direction, i.e., the longitudinal direction. Note that, in an embodiment, a size and a position of a region in which the negative electrode active material layer 22B covers the outward surface 22A2 of the negative electrode current collector 22A and a size and a position of a region in which the negative electrode active material layer 22B covers the inward surface 22A1 of the negative electrode current collector 22A may be different from each other. In an embodiment, the size and the position of the region in which the negative electrode active material layer 22B covers the outward surface 22A2 of the negative electrode current collector 22A and the size and the position of the region in which the negative electrode active material layer 22B covers the inward surface 22A1 of the negative electrode current collector 22A may be the same as each other.

The negative electrode lead 26 may be attached to the negative electrode current collector 22A in the negative electrode exposed region 222. For example, the negative electrode lead 26 may be attached to the negative electrode current collector 22A in the negative electrode exposed region 222 on the winding outer periphery side, of the two negative electrode exposed regions 222. The negative electrode lead 26 may be so provided that a portion of the negative electrode lead 26 protrudes downward from the lower edge 22BT of the negative electrode 22. In the configuration example illustrated in FIG. 2, the negative electrode lead 26 may be attached to a location on the negative electrode current collector 22A where no negative electrode active material layer 22B is provided on either of the inward surface 22A1 and the outward surface 22A2 of the negative electrode current collector 22A. In addition, in the configuration example illustrated in FIG. 2, the negative electrode lead 26 may be attached to the outward surface 22A2 on an outer side, i.e., a surface that is opposed to an inner surface of the battery can 11, out of the inward surface 22A1 and the outward surface 22A2 of the negative electrode current collector 22A.

As illustrated in FIG. 2, the protective tape 21C of the positive electrode 21 may cover an entire region, of the positive electrode exposed region 212 of the positive electrode 21, that is opposed to the negative electrode covered region 221 of the negative electrode 22 with the separator 23 interposed therebetween. The protective tape 21C helps to effectively prevent an internal short circuit of the secondary battery 1 when foreign matter enters between the negative electrode covered region 221 and the positive electrode exposed region 212, for example. Further, when the secondary battery 1 undergoes an impact, the protective tape 21C absorbs the impact, thereby helping to effectively prevent bending of the positive electrode exposed region 212 and a short circuit between the positive electrode exposed region 212 and the negative electrode 22. Further, even when a local increase in a potential occurs in the positive electrode covered region 211 in the vicinity of a border between the positive electrode covered region 211 and the positive electrode exposed region 212, the protective tape 21C helps to suppress outflow of metal ions from the positive electrode active material layer 21B and to prevent a short circuit between the positive electrode 21 and the negative electrode 22.

Further, in the electrode wound body 20, the negative electrode lead 26 and the negative electrode current collector 22A may be joined to each other and overlap each other in the stacking direction, i.e., the R direction of the positive electrode 21 and the negative electrode 22, forming an overlapping region. All of the overlapping region may overlap the protective tape 21C in the R direction. In other words, all of a portion of the negative electrode current collector 22A to which the negative electrode lead 26 is attached may be located at a position corresponding to the protective tape 21C in the R direction.

The separator 23 may be an insulating porous film interposed between the positive electrode 21 and the negative electrode 22. The separator 23 may allow lithium ions to pass therethrough while preventing a short circuit between the positive electrode 21 and the negative electrode 22. The separator 23 may include a polymer compound such as polyethylene.

The electrolytic solution may include a solvent and an electrolyte salt. The solvent may include any one or more of non-aqueous solvents (organic solvents) including, without limitation, a carbonic-acid-ester-based compound, a carboxylic-acid-ester-based compound, and a lactone-based compound. An electrolytic solution including any of the non-aqueous solvents may be what is called a non-aqueous electrolytic solution. However, in an embodiment, the solvent may be an aqueous solvent. The electrolyte salt may include any one or more of light metal salts including, without limitation, a lithium salt. A content of the electrolyte salt is not particularly limited. In an embodiment, the content of the electrolyte salt may be within a range from 0.3 mol/kg to 3 mol/kg both inclusive with respect to the solvent. One reason for this is that this helps to obtain high ion conductivity.

In the secondary battery 1 according to an embodiment, for example, upon charging, lithium ions may be extracted from the positive electrode 21, and the extracted lithium ions may be inserted into the negative electrode 22 via the electrolytic solution. In the secondary battery 1, for example, upon discharging, lithium ions may be extracted from the negative electrode 22, and the extracted lithium ions may be inserted into the positive electrode 21 via the electrolytic solution.

A description is given next of a method of manufacturing the secondary battery 1 according to an embodiment of the present disclosure.

First, the positive electrode active material may be mixed with materials including, without limitation, the positive electrode binder and the positive electrode conductor on an as-needed basis to thereby obtain a positive electrode mixture. Thereafter, the positive electrode mixture may be dispersed in a solvent to thereby obtain a positive electrode mixture slurry in paste form. The solvent is not limited to a particular kind, and the solvent may be an aqueous solvent or a non-aqueous solvent (an organic solvent). Thereafter, the positive electrode mixture slurry may be applied on the two opposite surfaces of the positive electrode current collector 21A to thereby form the positive electrode active material layers 21B. Thereafter, the positive electrode active material layers 21B may be compression-molded by means of, for example, a roll pressing machine. In this case, in an embodiment, the positive electrode active material layers 21B may be heated. In an embodiment, the positive electrode active material layers 21B may be compression-molded multiple times. Further, a portion of the positive electrode active material layer 21B may be removed by, for example, laser ablation, to thereby form the thin part 61. In this manner, the positive electrode active material layers 21B each including the thin part 61 and the thick parts 71 to 73 may be formed on the respective two opposite surfaces of the positive electrode current collector 21A. Thereafter, the protective tape 21C may be attached to a predetermined location on the positive electrode current collector 21A. The positive electrode 21 may be thereby fabricated.

The negative electrode active material layers 22B may be formed on the respective two opposite surfaces of the negative electrode current collector 22A by a procedure similar to that of the positive electrode 21 described above. For example, the negative electrode active material may be mixed with materials including, without limitation, the negative electrode binder and the negative electrode conductor to thereby obtain a negative electrode mixture. Thereafter, the negative electrode mixture may be dispersed in a solvent to thereby obtain a negative electrode mixture slurry in paste form. Details of the solvent may be as described above. Thereafter, the negative electrode mixture slurry may be applied on the two opposite surfaces of the negative electrode current collector 22A to thereby form the negative electrode active material layers 22B. Thereafter, the negative electrode active material layers 22B may be compression-molded by means of, for example, a roll pressing machine. Details of compression molding may be as described above. In this manner, the negative electrode active material layers 22B may be formed on the respective two opposite surfaces of the negative electrode current collector 22A. As a result, the negative electrode 22 may be fabricated.

First, the positive electrode lead 25 may be coupled to the positive electrode current collector 21A of the positive electrode 21 by a method such as a welding method. In a similar manner, the negative electrode lead 26 may be coupled to the negative electrode current collector 22A of the negative electrode 22 by a method such as a welding method. Thereafter, the positive electrode 21 and the negative electrode 22 may be stacked on each other with the separator 23 interposed therebetween to form a stacked body, following which the obtained stacked body may be wound to thereby form a wound body having the through hole 20C. Upon fabricating the wound body, the positive electrode 21 and the negative electrode 22 may be so aligned with each other that an entire region where the negative electrode lead 26 and the negative electrode current collector 22A overlap each other in the stacking direction of the positive electrode 21 and the negative electrode 22, i.e., all of the overlapping region, overlaps the protective tape 21C in the stacking direction. The wound body may have a configuration similar to that of the electrode wound body 20 except that the positive electrode 21, the negative electrode 22, and the separator 23 are each not impregnated with the electrolytic solution.

Thereafter, the battery can 11 may be prepared, following which the insulating plates 12 and 13 may be opposed to each other with the wound body interposed therebetween, and the wound body, together with the insulating plates 12 and 13, may be placed inside the battery can 11. In this case, the positive electrode lead 25 may be coupled to the safety valve mechanism 30 by a method such as a welding method, and the negative electrode lead 26 may be coupled to the battery can 11 by a method such as a welding method.

Thereafter, the electrolytic solution may be injected into the battery can 11 to thereby impregnate the wound body with the electrolytic solution. As a result, the positive electrode 21, the negative electrode 22, and the separator 23 may each be impregnated with the electrolytic solution, and the electrode wound body 20 may thereby be fabricated. Thereafter, the battery cover 14 and the safety valve mechanism 30 may be placed inside the battery can 11 together with the gasket 15.

Thereafter, the open end part 11N and both the battery cover 14 and the safety valve mechanism 30 may be crimped to each other with the gasket 15 interposed therebetween at the open end part 11N of the battery can 11, as illustrated in FIG. 1. In such a manner, the bent part 11P may be formed, and the crimped structure 11R may thereby be formed. As a result, the battery can 11 may be closed by the battery cover 14 to finish the assembly of the secondary battery 1.

The assembled secondary battery 1 may be charged and discharged. Various conditions including, for example, an environment temperature, the number of times of charging and discharging (the number of cycles), and charging and discharging conditions may be set as desired. A film may thereby be formed on a location such as a location on a surface of the negative electrode 22. This may bring the secondary battery 1 into an electrochemically stable state. As a result, the secondary battery 1 of the cylindrical type may be completed in which the electrode wound body 20 and other components are sealed inside the battery can 11.

In the secondary battery 1 according to an embodiment, the thin part 61 and the thick part 71 are provided to be adjacent to each other in the W direction in the positive electrode active material layer 21B, as described above. The W direction may be the direction orthogonal to the winding direction, i.e., the L direction. Thus providing the thin part 61 having the small thickness in a portion of the positive electrode active material layer 21B helps to suppress concentration of stress inside the electrode wound body 20 contained in the battery can 11. For example, this helps to prevent great deformation, such as buckling or bending, of the positive electrode current collector 21A when the negative electrode 22 swells inside the electrode wound body 20 upon charging and discharging. One reason for this is that reducing the amount of the electrode reactant, such as lithium ions, supplied to a partial region of the negative electrode active material layer 22B opposed to the thin part 61 suppresses expansion and contraction of the partial region of the negative electrode active material layer 22B opposed to the thin part 61. As a result, the stress applied to the separator 23 separating the positive electrode 21 and the negative electrode 22 from each other is also reduced, which helps to avoid breakage of the separator 23 and thereby prevent a short circuit between the positive electrode 21 and the negative electrode 22, even when the separator 23 has a reduced thickness. In other words, it helps to allow for reduction in the thickness of the separator 23. The reduction in the thickness of the separator 23 allows a spacing between the positive electrode 21 and the negative electrode 22 to be reduced, which decreases the internal resistance of the electrode wound body 20. This helps to improve a rate characteristic at the time of charging and discharging and to increase the capacity of the secondary battery 1, for example. In addition, the positive electrode active material layer 21B including the thick part 71 at the position adjacent to the thin part 61 in the W direction helps to allow the separator 23 disposed between the positive electrode active material layer 21B and the negative electrode active material layer 22B to be firmly held. This helps to prevent easy occurrence of winding displacement of the electrode wound body 20 upon expansion and contraction of the electrode wound body 20, and thus helps to prevent the separator 23 from being displaced from a predetermined position. This helps to prevent a short circuit between the positive electrode 21 and the negative electrode 22. Accordingly, the secondary battery 1 according to an embodiment helps to achieve superior reliability.

In an embodiment, the thin part 61 may include the winding center side edge 21BS of the positive electrode active material layer 21B in the L direction. In other words, the thin part 61 may be provided at a position closest to the winding center in the positive electrode active material layer 21B. This helps to effectively suppress, in the region inside the electrode wound body 20, concentration of stress at and near the winding center of the electrode wound body 20 where the concentration of stress tends to occur markedly easily.

In an embodiment, the positive electrode active material layer 21B may further include the thick part 72 that includes the lower edge 21BT positioned on the opposite side to the upper edge 21UT in the W direction. This helps to allow the separator 23 disposed between the positive electrode active material layer 21B and the negative electrode active material layer 22B to be held more firmly.

In an embodiment, the positive electrode active material layer 21B may further include the thick part 73 provided on the opposite side of the thin part 61 to the winding center side edge 21BS of the positive electrode active material layer 21B in the L direction. This helps to obtain a predetermined battery capacity while suppressing concentration of stress at and near the winding center of the electrode wound body 20.

In an embodiment, each of the inner winding side positive electrode active material layer 21B1 and the outer winding side positive electrode active material layer 21B2 may include the thin part 61 and the thick parts 71 to 73. This helps to further effectively suppress the concentration of stress at and near the winding center of the electrode wound body 20. In an embodiment, the thin part 61 may be provided in a region including the middle of the positive electrode 21 in the W direction, i.e., the width direction of the positive electrode 21. This helps to effectively suppress the concentration of stress inside the electrode wound body 20.

In an embodiment, the secondary battery 1 may include a lithium-ion secondary battery. This helps to allow a sufficient battery capacity to be obtained stably through insertion and extraction of lithium. This helps to achieve higher operation reliability.

Non-limiting examples of applications of the secondary battery 1 according to an embodiment of the present disclosure may be as described below.

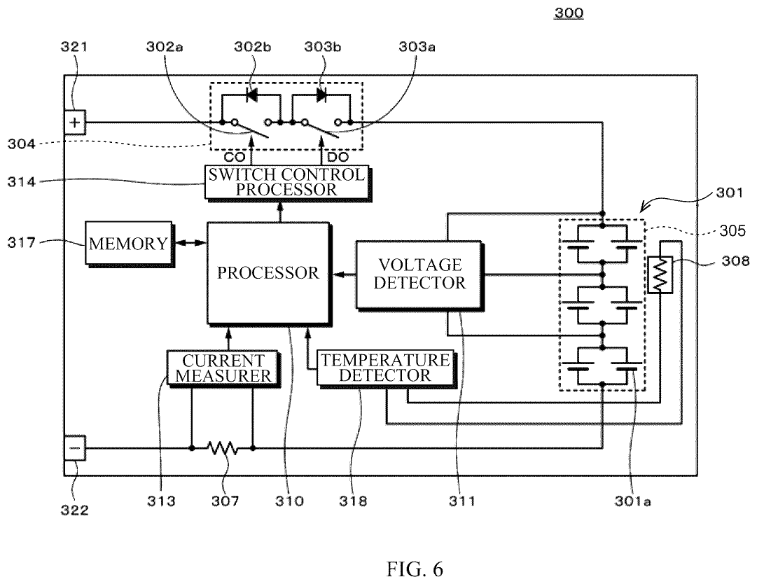

FIG. 6 is a block diagram illustrating a circuit configuration example in which the secondary battery 1 according to an embodiment of the present disclosure is applied to a battery pack 300. The battery pack 300 may include an assembled battery 301, a switcher 304, an outer package body 305, a current detection resistor 307, a temperature detection device 308, and a processor 310. The switcher 304 may include a charge control switch 302a and a discharge control switch 303a. The outer package body 305 may contain the assembled battery 301.

The battery pack 300 may include a positive electrode terminal 321 and a negative electrode terminal 322. Upon charging, the positive electrode terminal 321 and the negative electrode terminal 322 may be respectively coupled to a positive electrode terminal and a negative electrode terminal of a charger to perform charging. Upon use of electronic equipment, the positive electrode terminal 321 and the negative electrode terminal 322 may be respectively coupled to a positive electrode terminal and a negative electrode terminal of the electronic equipment to perform discharging.

The assembled battery 301 may include secondary batteries 301a coupled in series or in parallel. The secondary battery 1 described above is applicable to each of the secondary batteries 301a. FIG. 6 illustrates an example case in which six secondary batteries 301a are coupled in a two parallel coupling and three series coupling (2P3S) configuration; however, the secondary batteries 301a may be coupled in any other manner such as in any n parallel coupling and m series coupling configuration, where each of n and m is an integer.

The switcher 304 may include the charge control switch 302a, a diode 302b, the discharge control switch 303a, and a diode 303b, and may be controlled by the processor 310. The diode 302b may have a polarity that is in a reverse direction with respect to a charge current flowing in a direction from the positive electrode terminal 321 to the assembled battery 301, and that is in a forward direction with respect to a discharge current flowing in a direction from the negative electrode terminal 322 to the assembled battery 301. The diode 303b may have a polarity that is in the forward direction with respect to the charge current and in the reverse direction with respect to the discharge current. In FIG. 6, the switcher 304 may be provided on a positive side; however, in an embodiment, the switcher 304 may be provided on a negative side.

The charge control switch 302a may be so controlled by a charge and discharge control processor that when the battery voltage reaches an overcharge detection voltage, the charge control switch 302a is turned off to thereby prevent the charge current from flowing through a current path of the assembled battery 301. After the charge control switch 302a is turned off, simply discharging may be enabled through the diode 302b. Further, the charge control switch 302a may be so controlled by the processor 310 that when a large current flows upon charging, the charge control switch 302a is turned off to thereby block the charge current flowing through the current path of the assembled battery 301. The discharge control switch 303a may be so controlled by the processor 310 that when the battery voltage reaches an overdischarge detection voltage, the discharge control switch 303a is turned off to thereby prevent the discharge current from flowing through the current path of the assembled battery 301. After the discharge control switch 303a is turned off, simply charging may be enabled through the diode 303b. Further, the discharge control switch 303a may be so controlled by the processor 310 that when a large current flows upon discharging, the discharge control switch 303a is turned off to thereby block the discharge current flowing through the current path of the assembled battery 301.

The temperature detection device 308 may be, for example, a thermistor. The temperature detection device 308 may be provided in the vicinity of the assembled battery 301. The temperature detection device 308 may measure a temperature of the assembled battery 301 and may supply data regarding the measured temperature to the processor 310. A voltage detector 311 may measure a voltage of the assembled battery 301 and a voltage of each of the secondary batteries 301a included therein, may perform A/D conversion on the measured voltages, and may supply data regarding the converted voltages to the processor 310. A current measurer 313 may measure a current by means of the current detection resistor 307 and may supply data regarding the measured current to the processor 310. A switch control processor 314 may control the charge control switch 302a and the discharge control switch 303a of the switcher 304, based on data regarding the voltages supplied from the voltage detector 311 and data regarding the current supplied from the current measurer 313.

When a voltage of any of the secondary batteries 301a reaches the overcharge detection voltage or below, or reaches the overdischarge detection voltage or below, or when a large current flows suddenly, the switch control processor 314 may transmit a control signal to the switcher 304 to thereby prevent overcharging and overdischarging, and overcurrent charging and discharging. For example, when the secondary battery 1 is a lithium-ion secondary battery, the overcharge detection voltage may be determined to be, for example, 4.20 V±0.05 V, and the overdischarge detection voltage may be determined to be, for example, 2.4 V±0.1 V.

As the charge control switch 302a and the discharge control switch 303a, for example, semiconductor switches such as metal-oxide-semiconductor field-effect transistors (MOSFETs) may be used. In this case, parasitic diodes of the MOSFETs may serve as the diodes 302b and 303b. When P-channel FETs are used as the charge control switch 302a and the discharge control switch 303a, the switch control processor 314 may supply control signals DO and CO to a gate of the charge control switch 302a and a gate of the discharge control switch 303a, respectively. When the charge control switch 302a and the discharge control switch 303a are of a P-channel type, the charge control switch 302a and the discharge control switch 303a may each be turned on by a gate potential that is lower than a source potential by a predetermined value or more. For example, in normal charging and discharging operations, the control signals CO and DO may be set to a low level to turn on the charge control switch 302a and the discharge control switch 303a.

For example, upon overcharging or overdischarging, the control signals CO and DO may be set to a high level to turn off the charge control switch 302a and the discharge control switch 303a.

A memory 317 may include a random-access memory (RAM) and a read only memory (ROM). For example, the memory 317 may include a nonvolatile memory such as an erasable programmable read only memory (EPROM). In the memory 317, values including, without limitation, numerical values calculated by the processor 310 and a battery's internal resistance value of each of the secondary batteries 301a in an initial state measured in the manufacturing process stage, may be stored in advance and may be rewritable on an as-needed basis. Further, storing data regarding a full charge capacity of the secondary battery 301a in the memory 317 allows the processor 310 to calculate, for example, a remaining capacity.

A temperature detector 318 may measure a temperature with use of the temperature detection device 308, may perform charge and discharge control upon abnormal heat generation, and may perform correction in calculating the remaining capacity.

The above-described secondary battery 1 according to an embodiment of the present disclosure is mountable on, or usable to supply electric power to, for example, any of equipment including, without limitation, electronic equipment, an electric tool, an electric vehicle, an electric aircraft, and a power storage apparatus.

Non-limiting examples of the electronic equipment may include laptop personal computers, smartphones, tablet terminals, personal digital assistants (PDAs) as mobile information terminals, mobile phones, wearable terminals, cordless phone handsets, hand-held video recording and playback devices, digital still cameras, electronic books, electronic dictionaries, music players, radios, headphones, game machines, navigation systems, memory cards, pacemakers, hearing aids, electric shavers, refrigerators, air conditioners, televisions, stereos, water heaters, microwave ovens, dishwashers, washing machines, dryers, lighting equipment, toys, medical equipment, robots, road conditioners, traffic lights, and any other electronic equipment to which any embodiment of the present disclosure is applicable.

Non-limiting examples of the electric vehicle may include railway vehicles, golf carts, electric carts, electric automobiles including hybrid electric automobiles, and any electric vehicle to which any embodiment of the present disclosure is applicable. The secondary battery 1 may be used as a driving power source or an auxiliary power source for any of these electric vehicles. Non-limiting examples of the power storage apparatuses may include a power storage power source for architectural structures including residential houses, or for power generation facilities, and any other power storage apparatus to which any embodiment of the present disclosure is applicable.

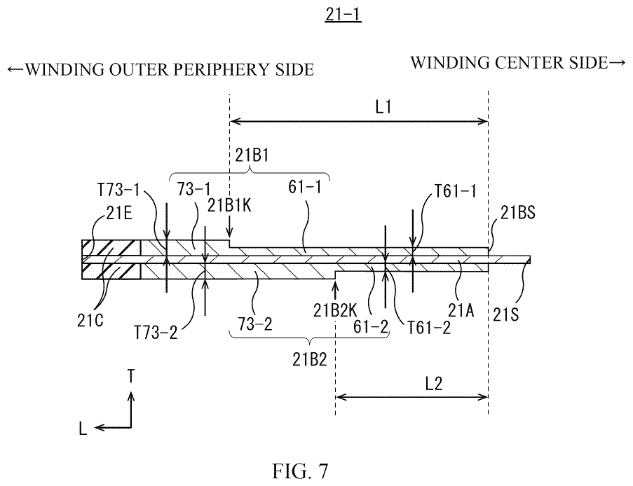

Next, a description is given of a positive electrode 21-1 according to a first modification example. The positive electrode 21-1 may be applied to the secondary battery 1 according to an embodiment described above. FIG. 7 illustrates a sectional configuration of the positive electrode 21-1 and corresponds to FIG. 5B illustrating the positive electrode 21 according to an embodiment described above.

As illustrated in FIG. 7, in the positive electrode 21-1 according to the first modification example, the position of the border 21B1K in the L direction and the position of the border 21B2K in the L direction may be different from each other. For example, a length L1 from the winding center side edge 21BS of the positive electrode active material layer 21B to the position of the border 21B1K and a length L2 from the winding center side edge 21BS of the positive electrode active material layer 21B to the position of the border 21B2K may be different from each other. Except for the above-described points, the positive electrode 21-1 may have a configuration substantially the same as the configuration of the positive electrode 21 according to an embodiment described above. The length L1 may correspond to a specific but non-limiting example of a “first length” in an embodiment of the present disclosure. The length L2 may correspond to a specific but non-limiting example of a “second length” in an embodiment of the present disclosure.

As described above, in the positive electrode 21-1, the position of the border 21B1K in the L direction and the position of the border 21B2K in the L direction may be different from each other. For example, a position where a level difference is present in the inner winding side positive electrode active material layer 21B1 and a position where a level difference is present in the outer winding side positive electrode active material layer 21B2 may be different from each other in the L direction. This allows a location where stress is concentrated in the inward surface 21A1 of the positive electrode current collector 21A due to swelling of the negative electrode 22 and a location where stress is concentrated in the outward surface 21A2 of the positive electrode current collector 21A due to the swelling of the negative electrode 22 not to coincide with each other. Accordingly, the stress applied to the positive electrode current collector 21A is dispersed. The secondary battery 1 that includes the electrode wound body 20 including the positive electrode 21-1 according to the first modification example thus helps to still further suppress the concentration of stress inside the electrode wound body 20 occurring due to expansion and contraction, as compared with when the secondary battery 1 includes the positive electrode 21 according to an embodiment described above.

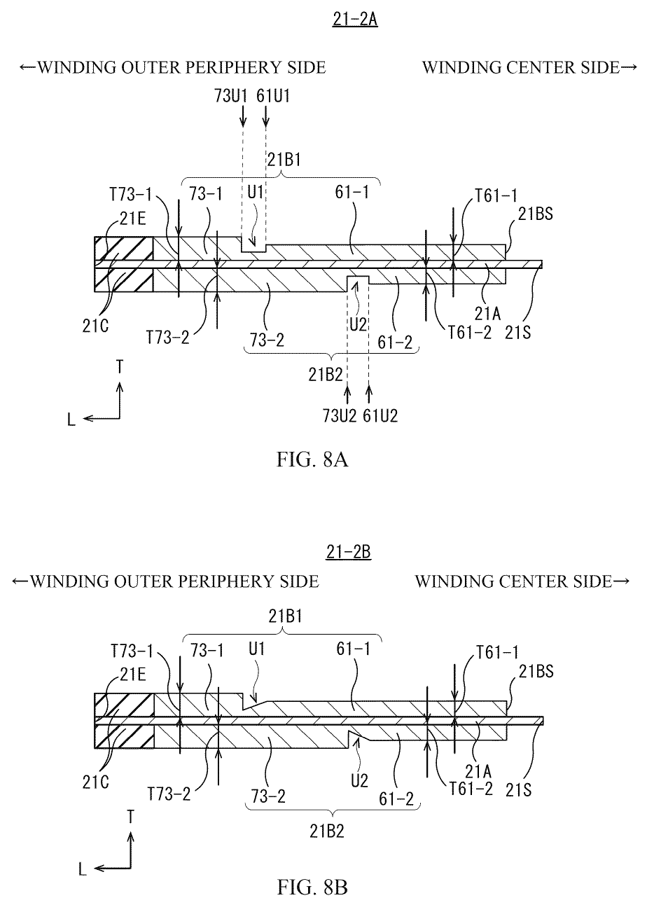

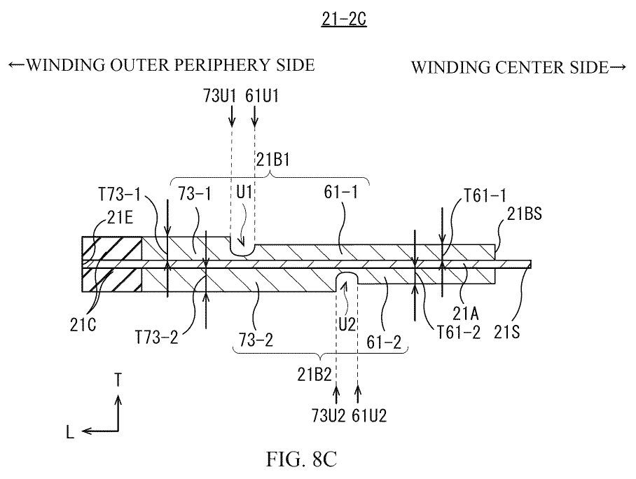

Next, a description is given of a positive electrode 21-2 according to a second modification example, i.e., positive electrodes 21-2A to 21-2C. The positive electrode 21-2, i.e., each of the positive electrodes 21-2A to 21-2C, may be applied to the secondary battery 1 according to an embodiment described above. FIGS. 8A to 8C respectively illustrate sectional configurations of the positive electrodes 21-2A to 21-2C and each correspond to FIG. 5B illustrating the positive electrode 21 according to an embodiment described above.

As illustrated in corresponding one of FIGS. 8A to 8C, in each of the positive electrodes 21-2A to 21-2C according to the second modification example, the inner winding side positive electrode active material layer 21B1 may further include a grooved part U1 between the thick part 73-1 and the thin part 61-1, and the outer winding side positive electrode active material layer 21B2 may further include a grooved part U2 between the thick part 73-2 and the thin part 61-2. Each of the grooved parts U1 and U2 may extend in the W direction. The grooved part U1 may have a thickness still smaller than the thickness T61-1 of the thin part 61-1 of the inner winding side positive electrode active material layer 21B1. Similarly, the grooved part U2 may have a thickness still smaller than the thickness T61-2 of the thin part 61-2 of the outer winding side positive electrode active material layer 21B2. In the positive electrode 21-2A of FIG. 8A, the grooved parts U1 and U2 may each have a substantially rectangular sectional shape. In the positive electrode 21-2B of FIG. 8B, the grooved parts U1 and U2 may each have a substantially V-shaped sectional shape. In the positive electrode 21-2C of FIG. 8C, the grooved parts U1 and U2 may each have a substantially U-shaped sectional shape. However, the sectional shapes of the grooved parts U1 and U2 are not limited to the shapes illustrated in FIGS. 8A to 8C, and may be chosen as desired.

In the positive electrodes 21-2A to 21-2C, a width of the grooved part U1 and a width of the grooved part U2 may be equal to each other in the L direction, or may be different from each other in the L direction. The width of the grooved part U1 may refer to a length in the L direction from a position of a border 73U1 between the thick part 73-1 and the grooved part U1 to a position of a border 61U1 between the thin part 61-1 and the grooved part U1. The width of the grooved part U2 may refer to a length in the L direction from a position of a border 73U2 between the thick part 73-2 and the grooved part U2 to a position of a border 61U2 between the thin part 61-2 and the grooved part U2. Each of the width of the grooved part U1 and the width of the grooved part U2 may be about 150 μm, for example.

Furthermore, in each of the configuration examples of the positive electrodes 21-2A to 21-2C respectively illustrated in FIGS. 8A to 8C, the position of the border 73U1 in the L direction and the position of the border 73U2 in the L direction may be different from each other, and the position of the border 61U1 in the L direction and the position of the border 61U2 in the L direction may be different from each other. However, in an embodiment, the position of the border 73U1 in the L direction and the position of the border 73U2 in the L direction may coincide with each other. In an embodiment, the position of the border 61U1 in the L direction and the position of the border 61U2 in the L direction may coincide with each other. In an embodiment, the position of the border 73U1 in the L direction and the position of the border 73U2 in the L direction may coincide with each other, and additionally, the position of the border 61U1 in the L direction and the position of the border 61U2 in the L direction may coincide with each other.

For example, in each of the configuration examples of the positive electrodes 21-2A to 21-2C respectively illustrated in FIGS. 8A to 8C, the inner winding side positive electrode active material layer 21B1 may include the grooved part U1, and the outer winding side positive electrode active material layer 21B2 may include the grooved part U2. However, in an embodiment, either the grooved part U1 or the grooved part U2 may be simply provided. In an embodiment, each of the positive electrodes 21-2A to 21-2C may simply include either the inner winding side positive electrode active material layer 21B1 or the outer winding side positive electrode active material layer 21B2.

As described above, each of the positive electrodes 21-2A to 21-2C according to the second modification example may have the grooved part U1, the grooved part U2, or both. When the secondary battery 1 includes any of the positive electrodes 21-2A to 21-2C, this helps to allow the separator 23 to be held more firmly between corresponding one of the positive electrodes 21-2A to 21-2C and the negative electrode 22. One reason for this is that the separator 23 being partly disposed in the grooved part U1, the grooved part U2, or both helps to prevent the separator 23 interposed between the corresponding one of the positive electrodes 21-2A to 21-2C and the negative electrode 22 from being easily displaced or detached from the predetermined position. As a result, the secondary battery 1 including any of the positive electrodes 21-2A to 21-2C helps to effectively prevent a short circuit between the corresponding one of the positive electrodes 21-2A to 21-2C and the negative electrode 22. This helps to achieve further superior reliability.

Next, referring to FIGS. 9A and 9B, a description is given of a positive electrode 21-3 according to a third modification example. The positive electrode 21-3 may be applied to the secondary battery 1 according to an embodiment described above. FIG. 9A is a plan diagram illustrating the positive electrode 21-3 and corresponds to FIG. 4A illustrating the positive electrode 21 according to an embodiment described above. FIG. 9B is a sectional view of the positive electrode 21-3 and corresponds to FIG. 5B illustrating the positive electrode 21 according to an embodiment described above. Note that FIG. 9B illustrates a section as viewed in an arrowed direction along line IXB-IXB illustrated in FIG. 9A. FIG. 9B omits illustration of the positive electrode lead 25 and the protective tape 21C.

As illustrated in FIGS. 9A and 9B, the positive electrode active material layer 21B of the positive electrode 21-3 may further include a thin part 62. The thin part 62 may be positioned on an opposite side of the thick part 73 to the thin part 61. A thickness of the thin part 62 may be smaller than a thickness of the thick part 73. The thin part 62 may include a winding outer periphery side edge 21BE of the positive electrode active material layer 21B in the L direction. The positive electrode active material layer 21B may further include a thick part 74 adjacent to the thin part 62 in the W direction. For example, the thick part 74 may be positioned between the thin part 62 and the upper edge 21UT in the W direction. The thick part 74 may include the upper edge 21UT. The positive electrode active material layer 21B may further include a thick part 75. The thick part 75 may include the lower edge 21BT. The thin part 62 may correspond to a specific but non-limiting example of a “second thin part” in an embodiment of the present disclosure.

In the positive electrode 21-3 according to the third modification example, the thin part 62 may be provided on each of the inward surface 21A1 of the positive electrode current collector 21A and the outward surface 21A2 of the positive electrode current collector 21A. In other words, each of the inner winding side positive electrode active material layer 21B1 and the outer winding side positive electrode active material layer 21B2 may include the thin part 62. In an embodiment, however, in the positive electrode 21-3, at least either the inner winding side positive electrode active material layer 21B1 or the outer winding side positive electrode active material layer 21B2 may include the thin part 62. Note that, for convenience, in FIG. 9B, the thin part 62 included in the inner winding side positive electrode active material layer 21B1 is denoted as a thin part 62-1, and the thin part 62 included in the outer winding side positive electrode active material layer 21B2 is denoted as a thin part 62-2. Further, in the modification example illustrated in FIG. 9B, a position of a border 21B1K1 between the thin part 61-1 and the thick part 73-1 in the L direction may substantially coincide with a position of a border 21B2K1 between the thin part 61-2 and the thick part 73-2 in the L direction. Further, in the modification example illustrated in FIG. 9B, a position of a border 21B1K2 between the thin part 62-1 and the thick part 73-1 in the L direction may substantially coincide with a position of a border 21B2K2 between the thin part 62-2 and the thick part 73-2 in the L direction.

As described above, the positive electrode 21-3 according to the third modification example may include, in addition to the thin part 61, the thin part 62 on the winding outer periphery side of the electrode wound body 20. This helps to reduce, on the winding outer periphery side of the electrode wound body 20, a level difference between a region where the positive electrode 21 is present and a region where no positive electrode 21 is present, as compared with when the positive electrode 21 with no thin part 62 is used. This helps to suppress concentration of stress on a location in the separator 23 that overlaps the winding outer periphery side edge 21BE. As a result, even when the separator 23 has a reduced thickness, it helps to avoid breakage of the separator 23 and thereby prevent a short circuit between the positive electrode 21 and the negative electrode 22. In other words, it helps to allow for reduction in the thickness of the separator 23. The reduction in the thickness of the separator 23 allows a spacing between the positive electrode 21 and the negative electrode 22 to be reduced, which decreases the internal resistance of the electrode wound body 20. This helps to improve a rate characteristic at the time of charging and discharging and to increase the capacity of the secondary battery 1, for example.

### EXAMPLES

A description is given of Examples of an embodiment of the present disclosure.

### Example 1-1

Secondary batteries of Example 1-1 were fabricated in accordance with the following procedure, following which the secondary batteries were each evaluated for a battery characteristic.

### [Fabrication of Secondary Battery]

The lithium-ion secondary battery of the cylindrical type illustrated in FIG. 1 (having a diameter, i.e., an outer diameter of 18 mm, and a length of 65 mm) was fabricated in accordance with the following procedure.

### [Fabrication of Positive Electrode]

First, 94 parts by mass of the positive electrode active material (LiNi_{0.8}Co_{0.15}Al_{0.05}), 3 parts by mass of the positive electrode binder (polyvinylidene difluoride), and 3 parts by mass of the positive electrode conductor (graphite) were mixed with each other to thereby obtain a positive electrode mixture. Thereafter, the positive electrode mixture was put into a solvent (N-methyl-2-pyrrolidone as an organic solvent), following which the organic solvent was stirred to thereby prepare a positive electrode mixture slurry in paste form. Thereafter, the positive electrode mixture slurry was applied on each of the two opposite surfaces of the positive electrode current collector 21A (a band-shaped aluminum foil having a thickness of 15 μm) by means of a coating apparatus, following which the applied positive electrode mixture slurry was dried to thereby form the positive electrode active material layers 21B. Thereafter, the positive electrode active material layers 21B were compression-molded by means of a roll pressing machine. Further, a portion of each of the positive electrode active material layers 21B was removed by laser ablation to thereby form the thin part 61. At this time, as illustrated in FIGS. 4A and 5A, portions of the positive electrode active material layer 21B were left unremoved to form the thick part 71 (i.e., each of the thick parts 71-1 and 71-2) and the thick part 72 (i.e., each of the thick parts 72-1 and 72-2). Note that, in Example 1-1, the width of each of the thick parts 71 and 72 in the W direction was set to 6 mm that corresponded to 10% of an entire width of 60 mm of the positive electrode covered region 211 in the W direction. In Example 1-1, the positions, the dimensions, and the shapes of the thin part 61-1 and the thick parts 71-1 to 73-1 of the inner winding side positive electrode active material layer 21B1 were substantially the same as the positions, the dimensions, and the shapes of the thin part 61-2 and the thick parts 71-2 to 73-2 of the outer winding side positive electrode active material layer 21B2, respectively. Here, a length of the thin part 61 in the L direction, i.e., the length from the winding center side edge 21BS of the positive electrode active material layer 21B to each of the borders 21B1K and 21B2K was 30 mm. In this manner, the positive electrode active material layer 21B including the thin part 61 and the thick parts 71 to 73 was formed on each of the two opposite surfaces of the positive electrode current collector 21A. Thereafter, the protective tape 21C was attached to a predetermined location on the positive electrode current collector 21A. The positive electrode 21 was thus obtained.

### [Fabrication of Negative Electrode]

First, 95 parts by mass of the negative electrode active material (graphite), 3 parts by mass of the negative electrode binder (styrene-butadiene rubber (SBR)), and 2 parts by mass of the negative electrode conductor (carbon black) were mixed with each other to thereby obtain a negative electrode mixture. Thereafter, the negative electrode mixture was put into a solvent (water), following which the solvent was stirred to thereby prepare a negative electrode mixture slurry in paste form. Thereafter, the negative electrode mixture slurry was applied on each of the two opposite surfaces of the negative electrode current collector 22A (a band-shaped copper foil having a thickness of 15 μm) by means of a coating apparatus, following which the applied negative electrode mixture slurry was dried to thereby form the negative electrode active material layers 22B. Thereafter, the negative electrode active material layers 22B were compression-molded by means of a roll pressing machine.

### [Preparation of Electrolytic Solution]

The electrolyte salt (LiPF₆) was added to the solvent (ethylene carbonate, ethyl methyl carbonate, and dimethyl carbonate), following which the solvent was stirred. In this case, a mixture ratio or a weight ratio between ethylene carbonate, ethyl methyl carbonate, and dimethyl carbonate in the solvent was set to 20:20:60, and the content of the electrolyte salt was set to 1 mol/kg with respect to the solvent.

### [Assembly of Secondary Battery]

First, the positive electrode lead 25 including aluminum was welded to the positive electrode current collector 21A of the positive electrode 21, and the negative electrode lead 26 including nickel was welded to the negative electrode current collector 22A of the negative electrode 22. Thereafter, the positive electrode 21 and the negative electrode 22 were stacked on each other with the separator 23 (a porous polyethylene film having a thickness of 16 μm) interposed therebetween, following which the stack of the positive electrode 21, the negative electrode 22, and the separator 23 was wound to thereby fabricate the wound body having the through hole 20C. Upon fabricating the wound body, the positive electrode 21 and the negative electrode 22 were so aligned with each other that an entire region where the negative electrode lead 26 and the negative electrode current collector 22A overlapped each other in the stacking direction of the positive electrode 21 and the negative electrode 22, i.e., all of the overlapping region overlapped the protective tape 21C in the stacking direction.

Thereafter, the wound body was placed, together with the pair of insulating plates 12 and 13, inside the battery can 11 that included iron and was nickel-plated. The positive electrode lead 25 was welded to the safety valve mechanism 30, and the negative electrode lead 26 was welded to the battery can 11. Thereafter, the electrolytic solution was injected into the battery can 11 by a reduced-pressure method to thereby cause the wound body to be impregnated with the electrolytic solution.

Thereafter, asphalt was added to a solvent (ethylcyclohexane as an organic solvent), following which the solvent was stirred to thereby prepare a coating solution. Thereafter, the coating solution was applied to the gasket 15 including polypropylene.

Thereafter, the open end part 11N of the battery can 11 and both the battery cover 14 and the safety valve mechanism 30 were crimped to each other with the gasket 15 including polypropylene interposed between the open end part 11N and both the battery cover 14 and the safety valve mechanism 30, to thereby form the crimped structure 11R.

The open end part 11N of the battery can 11 was thus closed by the battery cover 14, and the battery device and other components were contained inside the battery can 11. The cylindrical lithium-ion secondary battery was thus assembled.

### [Stabilization of Secondary Battery]

The secondary battery was charged and discharged for one cycle in an ambient temperature environment (at a temperature of 23° C.). Upon charging, the secondary battery was charged with a constant current of 0.1 C until a voltage reached 4.2 V, and was thereafter charged with a constant voltage of that value, i.e., 4.2 V until a current reached 0.05 C. Upon discharging, the secondary battery was discharged with a constant current of 0.1 C until the voltage reached 3.0 V. Note that 0.1 C was a value of a current that caused a battery capacity, i.e., a theoretical capacity, of 4000 mAh to be completely discharged in 10 hours, and 0.05 C was a value of a current that caused the battery capacity of 4000 mAh to be completely discharged in 20 hours.

The state of the secondary battery was thus electrochemically stabilized. As a result, the cylindrical lithium-ion secondary battery was completed.

### Example 1-2

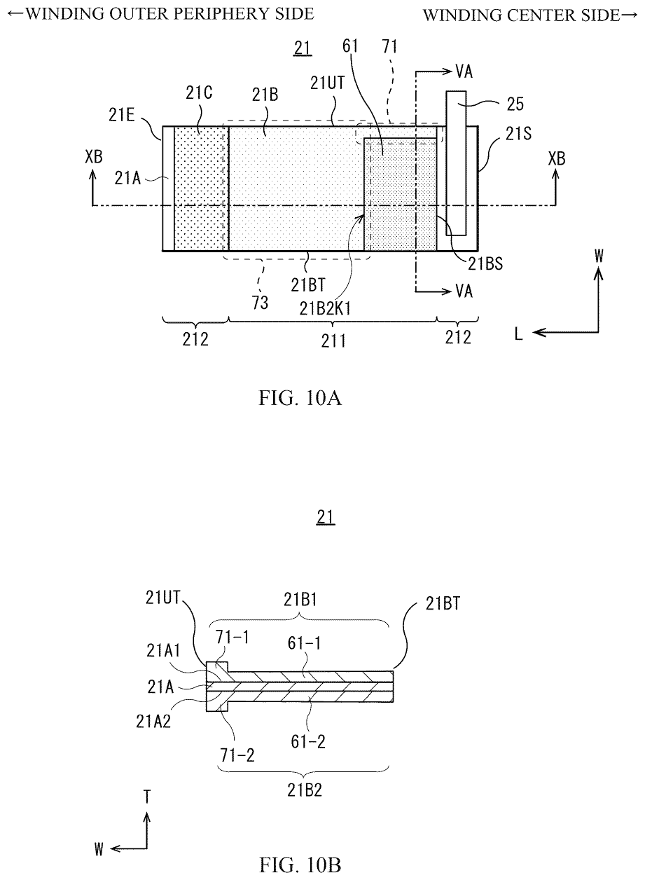

When forming the thin part 61 by laser ablation, the thick part 71 (i.e., each of the thick parts 71-1 and 71-2) was formed by leaving a portion of each of the positive electrode active material layers 21B unremoved, but no thick part 72 (i.e., neither of the thick parts 72-1 and 72-2) was formed, as illustrated in FIGS. 10A and 10B. FIG. 10A is a plan diagram illustrating the positive electrode 21 of Example 1-2, and FIG. 10B is a sectional view of the positive electrode 21 of Example 1-2. Except for the above-described point, secondary batteries of Example 1-2 were each fabricated in a manner similar to that of Example 1-1. Note that, in Example 1-2, the width of the thick part 71 in the W direction was set to 6 mm that corresponded to 10% of the entire width of 60 mm of the positive electrode covered region 211 in the W direction.

### Example 1-3

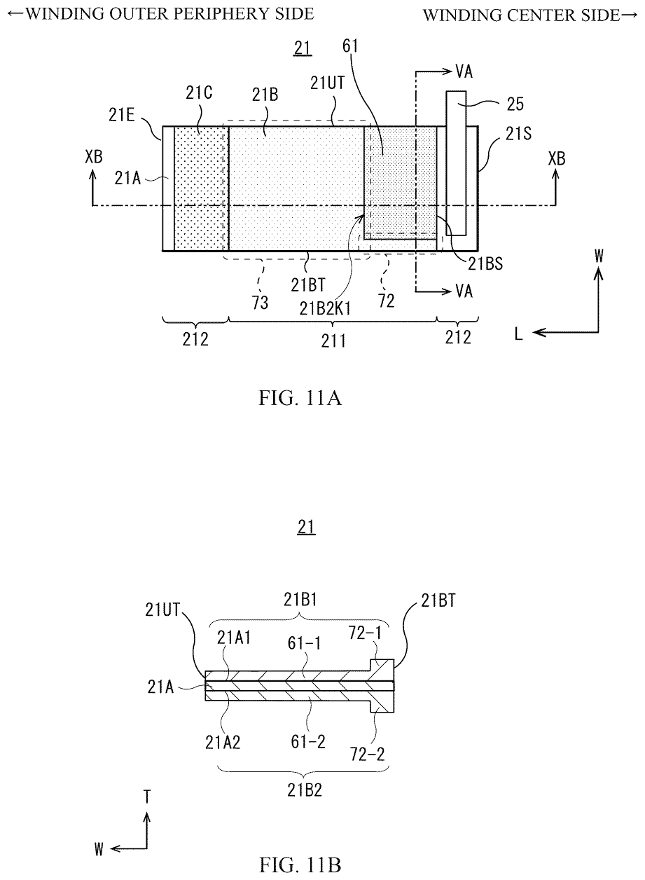

When forming the thin part 61 by laser ablation, the thick part 72 (i.e., each of the thick parts 72-1 and 72-2) was formed by leaving a portion of each of the positive electrode active material layers 21B unremoved, but no thick part 71 (i.e., neither of the thick parts 71-1 and 71-2) was formed, as illustrated in FIGS. 11A and 11B. FIG. 11A is a plan diagram illustrating the positive electrode 21 of Example 1-3, and FIG. 11B is a sectional view of the positive electrode 21 of Example 1-3. Except for the above-described point, secondary batteries of Example 1-3were each fabricated in a manner similar to that of Example 1-1. Note that, in Example 1-3, the width of the thick part 72 in the W direction was set to 6 mm that corresponded to 10% of the entire width of 60 mm of the positive electrode covered region 211 in the W direction.

### Example 2-1

Secondary batteries of Example 2-1 were each fabricated in a manner similar to that of Example 1-1 except that the positive electrode 21-1 illustrated in FIG. 7 was used instead of the positive electrode 21. In other words, when forming the thin part 61 by removing a portion of each of the positive electrode active material layers 21B by laser ablation, the position of the border 21B1K on the inner winding side positive electrode active material layer 21B1 in the L direction and the position of the border 21B2K on the outer winding side positive electrode active material layer 21B2 in the L direction were set to be different from each other.

### Example 2-2

When forming the thin part 61 by laser ablation, the thick part 71 (i.e., each of the thick parts 71-1 and 71-2) was formed by leaving a portion of each of the positive electrode active material layers 21B unremoved, but no thick part 72 (i.e., neither of the thick parts 72-1 and 72-2) was formed, as illustrated in FIGS. 10A and 10B. Except for the above-described point, secondary batteries of Example 2-2 were each fabricated in a manner similar to that of Example 2-1. Note that, in Example 2-2, the width of the thick part 71 in the W direction was set to 6 mm that corresponded to 10% of the entire width of 60 mm of the positive electrode covered region 211 in the W direction.

### Example 2-3

When forming the thin part 61 by laser ablation, the thick part 72 (i.e., each of the thick parts 72-1 and 72-2) was formed by leaving a portion of each of the positive electrode active material layers 21B unremoved, but no thick part 71 (i.e., neither of the thick parts 71-1 and 71-2) was formed, as illustrated in FIGS. 11A and 11B. Except for the above-described point, secondary batteries of Example 2-3 were each fabricated in a manner similar to that of Example 2-1. Note that, in Example 2-3, the width of the thick part 72 in the W direction was set to 6 mm that corresponded to 10% of the entire width of 60 mm of the positive electrode covered region 211 in the W direction.

### Example 3-1

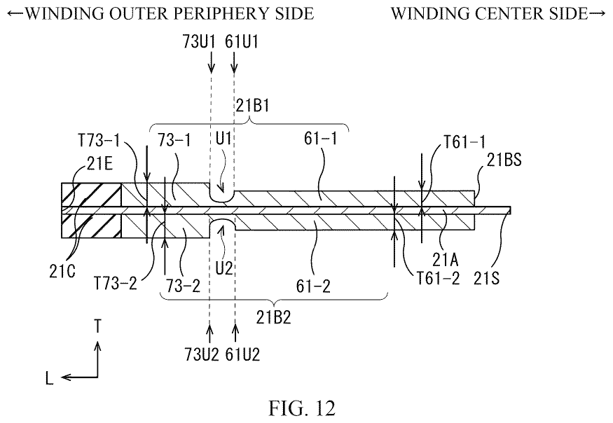

Secondary batteries of Example 3-1 were each fabricated in a manner similar to that of Example 1-1 except that a positive electrode 21-2D illustrated in FIG. 12 was used instead of the positive electrode 21. When forming the thin part 61 by removing a portion of each of the positive electrode active material layers 21B by laser ablation, the grooved parts U1 and U2 were each formed between the thin part 61 and the thick part 73: the grooved part U1 was formed between the thin part 61-1 and the thick part 73-1, and the grooved part U2 was formed between the thin part 61-2 and the thick part 73-2. When forming the grooved parts U1 and U2, the position of the grooved part U1 in the L direction was allowed to coincide with the position of the grooved part U2 in the L direction.

### Example 3-2

When forming the thin part 61 by laser ablation, the thick part 71 (i.e., each of the thick parts 71-1 and 71-2) was formed by leaving a portion of each of the positive electrode active material layers 21B unremoved, but no thick part 72 (i.e., neither of the thick parts 72-1 and 72-2) was formed, as illustrated in FIGS. 10A and 10B. Except for the above-described point, secondary batteries of Example 3-2 were each fabricated in a manner similar to that of Example 3-1. Note that, in Example 3-2, the width of the thick part 71 in the W direction was set to 6 mm that corresponded to 10% of the entire width of 60 mm of the positive electrode covered region 211 in the W direction.

### Example 3-3

When forming the thin part 61 by laser ablation, the thick part 72 (i.e., each of the thick parts 72-1 and 72-2) was formed by leaving a portion of each of the positive electrode active material layers 21B unremoved, but no thick part 71 (i.e., neither of the thick parts 71-1 and 71-2) was formed, as illustrated in FIGS. 11A and 11B. Except for the above-described point, secondary batteries of Example 3-3 were each fabricated in a manner similar to that of Example 3-1. Note that, in Example 3-3, the width of the thick part 72 in the W direction was set to 6 mm that corresponded to 10% of the entire width of 60 mm of the positive electrode covered region 211 in the W direction.

### Example 4-1

Secondary batteries of Example 4-1 were each fabricated in a manner similar to that of Example 1-1 except that the positive electrode 21-2C illustrated in FIG. 8C was used instead of the positive electrode 21. When forming the thin part 61 including the winding center side edge 21BS of the positive electrode active material layer 21B by removing a portion of each of the positive electrode active material layers 21B by laser ablation, the grooved parts U1 and U2 were each formed between the thin part 61 and the thick part 73: the grooved part U1 was formed between the thin part 61-1 and the thick part 73-1, and the grooved part U2 was formed between the thin part 61-2 and the thick part 73-2. When forming the grooved parts U1 and U2, the position of the grooved part U1 in the L direction was allowed to coincide with the position of the grooved part U2 in the L direction.

### Example 4-2

When forming the thin part 61 by laser ablation, the thick part 71 (i.e., each of the thick parts 71-1 and 71-2) was formed by leaving a portion of each of the positive electrode active material layers 21B unremoved, but no thick part 72 (i.e., neither of the thick parts 72-1 and 72-2) was formed, as illustrated in FIGS. 10A and 10B. Except for the above-described point, secondary batteries of Example 4-2 were each fabricated in a manner similar to that of Example 4-1. Note that, in Example 4-2, the width of the thick part 71 in the W direction was set to 6 mm that corresponded to 10% of the entire width of 60 mm of the positive electrode covered region 211 in the W direction.

### Example 4-3

When forming the thin part 61 by laser ablation, the thick part 72 (i.e., each of the thick parts 72-1 and 72-2) was formed by leaving a portion of each of the positive electrode active material layers 21B unremoved, but no thick part 71 (i.e., neither of the thick parts 71-1 and 71-2) was formed, as illustrated in FIGS. 11A and 11B. Except for the above-described point, secondary batteries of Example 4-3 were each fabricated in a manner similar to that of Example 4-1. Note that, in Example 4-3, the width of the thick part 72 in the W direction was set to 6 mm that corresponded to 10% of the entire width of 60 mm of the positive electrode covered region 211 in the W direction.

### Example 5-1

Out of the inner winding side positive electrode active material layer 21B1 and the outer winding side positive electrode active material layer 21B2 each provided on the positive electrode current collector 21A, the thin part 61 was provided simply in the inner winding side positive electrode active material layer 21B1 provided on the inward surface 21A1 of the positive electrode current collector 21A. In other words, in Example 5-1, no thin part 61 was formed in the outer winding side positive electrode active material layer 21B2 provided on the outward surface 21A2 of the positive electrode current collector 21A. In this case, the entire outer winding side positive electrode active material layer 21B2 had a uniform thickness. Except for the above-described point, secondary batteries of Examples 5-1 were each fabricated in a manner similar to that of Example 1-1.

### Example 5-2

Out of the inner winding side positive electrode active material layer 21B1 and the outer winding side positive electrode active material layer 21B2 each provided on the positive electrode current collector 21A, the thin part 61 was simply provided in the inner winding side positive electrode active material layer 21B1 provided on the inward surface 21A1 of the positive electrode current collector 21A. In other words, in Example 5-2, no thin part 61 was formed in the outer winding side positive electrode active material layer 21B2 provided on the outward surface 21A2 of the positive electrode current collector 21A. In this case, the entire outer winding side positive electrode active material layer 21B2 had a uniform thickness. Except for the above-described point, secondary batteries of Example 5-2 were each fabricated in a manner similar to that of Example 3-1.

### Comparative Example 1

No thin part 61 was formed in either the inner winding side positive electrode active material layer 21B1 or the outer winding side positive electrode active material layer 21B2 provided on the positive electrode current collector 21A. In this case, the entire inner winding side positive electrode active material layer 21B1 had a uniform thickness and the entire outer winding side positive electrode active material layer 21B2 also had a uniform thickness. Except for the above-described point, secondary batteries of Comparative example 1 were each fabricated in a manner similar to that of Example 1-1.

### Comparative Example 2

In each of the inner winding side positive electrode active material layer 21B1 and the outer winding side positive electrode active material layer 21B2 each provided on the positive electrode current collector 21A, the thin part 61 was formed to extend across the positive electrode covered region 211 in the W direction. In other words, neither of the thick parts 71 and 72 was formed. Except for the above-described point, secondary batteries of Comparative example 2 were each fabricated in a manner similar to that of Example 1-1.

### [Evaluation of Battery Characteristic]

Each of the secondary batteries of Examples 1-1 to 1-3, 2-1 to 2-3, 3-1 to 3-3, 4-1 to 4-3, 5-1 to 5-2, and Comparative examples 1 and 2 obtained as described above was examined in terms of presence or absence of defective winding, a short-circuit occurrence rate after initial cycle of charging and discharging, a positive electrode deformation amount after charging and discharging cycle, and a short-circuit occurrence rate after charging and discharging cycle. The results are presented in Table 1.

TABLE 1

| | | | | | | | After charging and | |
|---|---|---|---|---|---|---|---|---|
| | | | | | | | discharging cycle | |
| | | | | | | | Deformation | |
| | | | | | | After initial | amount of | |
| | Width of thick | | | | | cycle of | positive | |
| | part in positive | | | | | charging and | electrode | |
| | electrode | | | | | discharging | (middle | Short- |
| | (first thick | | Difference | | Defective | Short-circuit | part/winding | circuit |
| | part:second thick | Thin | in positions | Grooved | winding | occurrence | center side | occurrence |
| | part:overall width) | part | of borders | part | [ppm] | rate [ppm] | edge) [μm] | rate [%] |
| Example 1-1 | 10%:10%:100% | Both | No | Not | 0 | 0 | 45/24 | 0 |
| | | sides | | provided | | | | |
| Example 1-2 | 10%:0%:100% | Both | No | Not | 0 | 0 | 43/24 | 0 |
| | | sides | | provided | | | | |
| Example 1-3 | 0%: 10%:100% | Both | No | Not | 0 | 0 | 45/24 | 0 |
| | | sides | | provided | | | | |
| Example 2-1 | 10%:10%:100% | Both | Yes | Not | 0 | 0 | 43/24 | 0 |
| | | sides | | provided | | | | |
| Example 2-2 | 10%:0%:100% | Both | Yes | Not | 0 | 0 | 24/12 | 0 |
| | | sides | | provided | | | | |
| Example 2-3 | 0%:10%:100% | Both | Yes | Not | 0 | 0 | 22/11 | 0 |
| | | sides | | provided | | | | |
| Example 3-1 | 10%:10%:100% | Both | No | Provided | 0 | 0 | 22/11 | 0 |
| | | sides | | | | | | |
| Example 3-2 | 10%:0%:100% | Both | No | Provided | 0 | 0 | 18/10 | 0 |
| | | sides | | | | | | |
| Example 3-3 | 0%:10%:100% | Both | No | Provided | 0 | 0 | 10/8 | 0 |
| | | sides | | | | | | |
| Example 4-1 | 10%:10%:100% | Both | Yes | Provided | 0 | 0 | 7/4 | 0 |
| | | sides | | | | | | |
| Example 4-2 | 10%:0%:100% | Both | Yes | Provided | 0 | 0 | 7/4 | 0 |
| | | sides | | | | | | |
| Example 4-3 | 0%:10%:100% | Both | Yes | Provided | 0 | 0 | 3/4 | 0 |
| | | sides | | | | | | |
| Example 5-1 | 10%:10%:100% | One | — | Not | 0 | 0 | 30/18 | 0 |
| | | side | | provided | | | | |
| Example 5-2 | 10%:10%:100% | One | — | Provided | 0 | 0 | 22/12 | 0 |
| | | side | | | | | | |
| Comparative | No thin part | — | — | — | 0 | 0 | —/300 | 4 |
| example 1 | | | | | | | | |
| Comparative | 0%:0%:100% | Both | — | — | 200 | 0 | 95/98 | 2 |
| example 2 | | sides | | | | | | |

### [Presence or Absence of Defective Winding]

The electrode wound body of each of the secondary batteries was evaluated in terms of whether a physical short circuit occurred in a state where the electrolytic solution was uninjected. For the evaluation, the electrode wound body of each of the secondary batteries was subjected to a high potential test (HPT). Upon performing the HPT, a reference value of an insulation resistance was set to 0.2 kV. The number of samples was 10,000.

### [Short-Circuit Occurrence Rate After Initial Cycle of Charging and Discharging]

Whether a short circuit to be caused by a factor such as metal powder or other electrically conductive powder being mixed into the secondary battery had occurred was determined based on whether heat generation occurred after an initial cycle of charging and discharging. The number of samples was set to 10,000.

### [Positive Electrode Deformation Amount After Charging and Discharging Cycle]

Based on a computed tomography (CT) image, measured was an amount of projection of the positive electrode in the radial direction of the electrode wound body 20, caused in a middle part of the electrode wound body 20, i.e., a region including the borders 21B1K and 21B2K between the thin part 61 and the thick part 73 and the vicinity thereof, and in a region, of the electrode wound body 20, including the winding center side edge 21BS of the positive electrode active material layer 21B and the vicinity thereof. The number of samples was 100. For the evaluation, a cycle test was performed with the following test conditions.

### [Cycle Test Conditions]

(1) Ambient temperature at which the test was performed: 23° C.
(2) Charge conditions: Constant current and constant voltage (CC-CV) charging was performed. Charging was performed with a constant current of 10 A to a voltage of 4.2 V, following which charging was performed with a constant voltage of 4.2 V. A cutoff current was set to 1 A.
(3) Rest time after charging: 60 minutes.
(4) Discharge conditions: Constant current (CC) discharging was performed with a constant current of 50 A. A cutoff voltage was set to 2 V, or discharging was stopped when a temperature reached 85° C.
(5) Rest after discharging: A rest was taken until a battery surface temperature fell below 50° C.
(6) Number of cycles: 100 cycles.

### [Short Circuit Occurrence Rate After Charging and Discharging Cycle]

Each of the secondary batteries was subjected to a cycle test under the above-described test conditions. Thereafter, each of the secondary batteries was stored in an environment at 25° C. for one week. After the storage, if a voltage drop of 4.1 V or more was observed, it was determined that a short circuit had occurred.

As indicated in Table 1, in any of Examples 1-1 to 1-3, 2-1 to 2-3, 3-1 to 3-3, 4-1 to 4-3, and 5-1 to 5-2, none of the defective winding, the short circuit after initial cycle of charging and discharging, and the short circuit after charging and discharging cycle occurred. In contrast, in Comparative example 1, the short circuit after charging and discharging cycle occurred at a rate of 4%, that is, four samples out of 100 samples. In addition, in Comparative example 2, the defective winding occurred at a rate of 200 ppm, and the short circuit after charging and discharging cycle occurred at a rate of 2%, that is, two samples out of 100 samples.

The results described above demonstrated that the secondary battery of an embodiment of the present disclosure made it possible to achieve further superior reliability.

Although the present disclosure has been described hereinabove with reference to an embodiment including modification examples, a configuration of any embodiment of the present disclosure is not limited to the configurations described in relation to an embodiment including modification examples, and is therefore modifiable in a variety of ways. For example, in the foregoing example embodiment, the thin part 61 serving as the “first thin part” may be positioned to be in contact with the winding center side edge 21BS of the positive electrode active material layer 21B. However, an embodiment of the present disclosure is not limited to the above-described configuration. In an embodiment, the first thin part, e.g., the thin part 61, may be provided at a location, in the positive electrode active material layer 21B, away from the winding center side edge 21BS of the positive electrode active material layer 21B. Similarly, the thin part 62 serving as the “second thin part” does not necessarily have to be brought into contact with the winding outer periphery side edge 21BE of the positive electrode active material layer 21B. In an embodiment, the second thin part, e.g., the thin part 62, may be provided at a location, in the positive electrode active material layer 21B, away from the winding outer periphery side edge 21BE.

For example, in the foregoing example embodiment and modification examples, the description has been given of the case where the electrode reactant is lithium; however, the electrode reactant is not particularly limited. In an embodiment, the electrode reactant may be another alkali metal such as sodium or potassium, or may be an alkaline earth metal such as beryllium, magnesium, or calcium, as described above. In an embodiment, the electrode reactant may be another light metal such as aluminum.

The effects described herein are mere examples, and effects of an embodiment of the present disclosure are therefore not limited to those described herein. Accordingly, an embodiment of the present disclosure may achieve any other effect.

Furthermore, the present disclosure encompasses any possible combination of some or all of the various embodiments and the modification examples described herein and incorporated herein. It is possible to achieve at least the following configurations from the above-described example embodiments of the present disclosure.

(1)

A secondary battery including:
an electrode wound body including a stacked body and having a through hole, the stacked body including a positive electrode, a negative electrode, and a separator and being wound along a longitudinal direction of the stacked body, the through hole being provided through the electrode wound body in a width direction orthogonal to the longitudinal direction; and
an outer package can containing the electrode wound body, in which
the positive electrode includes
   a positive electrode active material layer extending in both the longitudinal direction and the width direction, and
   a positive electrode current collector including a positive electrode covered region and a positive electrode exposed region, the positive electrode covered region being covered with the positive electrode active material layer, the positive electrode exposed region being covered with no positive electrode active material layer and extending in the width direction from the positive electrode active material layer, and
   the positive electrode active material layer includes a first thin part and a first thick part, the first thick part having a thickness greater than a thickness of the first thin part and being adjacent to the first thin part in the width direction.
      (2)

The secondary battery according to (1), in which the first thin part includes a winding center side edge of the positive electrode active material layer in the longitudinal direction.

(3)

The secondary battery according to (1) or (2), in which
the positive electrode active material layer further includes a second thick part positioned on an opposite side of the first thin part to the first thick part in the width direction, and
the second thick part has a thickness greater than the thickness of the first thin part.
   (4)

The secondary battery according to (2), in which
the positive electrode active material layer further includes a third thick part positioned on an opposite side of the first thin part to the winding center side edge of the positive electrode active material layer in the longitudinal direction, and
the third thick part has a thickness greater than the thickness of the first thin part.
   (5)

The secondary battery according to any one of (1) to (4), in which
the positive electrode current collector includes an inward surface and an outward surface, the inward surface facing toward a winding center side of the electrode wound body, the outward surface facing toward an outer side opposite to the winding center side of the electrode wound body, and
each of the first thick part and the first thin part is provided on each of the inward surface and the outward surface of the positive electrode current collector.
   (6)

The secondary battery according to (4), in which
the positive electrode current collector includes an inward surface and an outward surface, the inward surface facing toward a winding center side of the electrode wound body, the outward surface facing toward an outer side opposite to the winding center side of the electrode wound body,
the positive electrode active material layer includes a first positive electrode active material layer and a second positive electrode active material layer, the first positive electrode active material layer being provided on the inward surface of the positive electrode current collector, the second positive electrode active material layer being provided on the outward surface of the positive electrode current collector,
each of the first positive electrode active material layer and the second positive electrode active material layer includes the first thin part, the first thick part, and the third thick part, and
a first length and a second length are different from each other, the first length being a length from the winding center side edge of the positive electrode active material layer in the longitudinal direction to a position of a first border between the first thin part of the first positive electrode active material layer and the third thick part of the first positive electrode active material layer, the second length being a length from the winding center side edge of the positive electrode active material layer in the longitudinal direction to a position of a second border between the first thin part of the second positive electrode active material layer and the third thick part of the second positive electrode active material layer.
   (7)

The secondary battery according to (4) or (6), in which
the positive electrode active material layer further includes a grooved part between the third thick part and the first thin part.
   (8)

The secondary battery according to any one of (4), (6), and (7), in which
the positive electrode active material layer further includes a second thin part on an opposite side of the third thick part to the first thin part, and
the second thin part has a thickness smaller than the thickness of the third thick part.
   (9) A battery pack including:
the secondary battery according to any one of (1) to (8);
a processor configured to control the secondary battery; and
an outer package body containing the secondary battery.

According to a secondary battery of at least an embodiment of the present disclosure and a battery pack including the secondary battery of at least an embodiment of the present disclosure, a positive electrode active material layer includes a first thin part. This helps to suppress concentration of stress inside an outer package can occurring due to swelling of a negative electrode. In addition, the positive electrode active material layer includes a first thick part adjacent to the first thin part. This helps to effectively prevent displacement of a separator positioned between a positive electrode and the negative electrode. This helps to prevent a short circuit between the positive electrode and the negative electrode and thereby achieve superior reliability.

Note that effects of an embodiment of the present disclosure are not necessarily limited to the example effects described above and may include any of a series of effects described herein in relation to an embodiments of the present disclosure and the modification examples thereof.

Although the present disclosure has been described hereinabove in terms of an embodiment and modification examples, the present disclosure is not limited thereto. It should be appreciated that variations may be made in the described example embodiment and modification examples by those skilled in the art without departing from the scope of the present disclosure as defined by the following claims.

The limitations in the claims are to be interpreted broadly based on the language employed in the claims and not limited to examples described in this specification or during the prosecution of the application, and the examples are to be construed as non-exclusive.

As used in this specification and the appended claims, the singular forms “a,” “an,” and “the” include, especially in the context of the claims, are to be construed to cover both the singular and the plural, unless otherwise indicated herein or clearly contradicted by context.

Throughout this specification and the appended claims, unless the context requires otherwise, the terms “comprise”, “include”, “have”, and their variations are to be construed to cover the inclusion of a stated element, integer, or step but not the exclusion of any other non-stated element, integer, or step.

The use of the terms first, second, etc. do not denote any order or importance, but rather the terms first, second, etc. are used to distinguish one element from another.

The term “substantially”, “approximately”, “about”, and its variants having the similar meaning thereto are defined as being largely but not necessarily wholly what is specified as understood by one of ordinary skill in the art.

The term “disposed on/provided on/formed on” and its variants having the similar meaning thereto as used herein refer to elements disposed directly in contact with each other or indirectly by having intervening structures therebetween.

It should be understood that various changes and modifications to the embodiments

described herein will be apparent to those skilled in the art. Such changes and modifications can be made without departing from the spirit and scope of the present subject matter and without diminishing its intended advantages. It is therefore intended that such changes and modifications be covered by the appended claims.

1. A secondary battery comprising:
an electrode wound body including a stacked body and having a through hole, the stacked body including a positive electrode, a negative electrode, and a separator and being wound along a longitudinal direction of the stacked body, the through hole being provided through the electrode wound body in a width direction orthogonal to the longitudinal direction; and
an outer package can containing the electrode wound body, wherein
the positive electrode includes
a positive electrode active material layer extending in both the longitudinal direction and the width direction, and
a positive electrode current collector including a positive electrode covered region and a positive electrode exposed region, the positive electrode covered region being covered with the positive electrode active material layer, the positive electrode exposed region being covered with no positive electrode active material layer and extending in the width direction from the positive electrode active material layer, and
the positive electrode active material layer includes a first thin part and a first thick part, the first thick part having a thickness greater than a thickness of the first thin part and being adjacent to the first thin part in the width direction.

2. The secondary battery according to claim 1, wherein the first thin part includes a winding center side edge of the positive electrode active material layer in the longitudinal direction.

3. The secondary battery according to claim 1, wherein
the positive electrode active material layer further includes a second thick part positioned on an opposite side of the first thin part to the first thick part in the width direction, and
the second thick part has a thickness greater than the thickness of the first thin part.

4. The secondary battery according to claim 2, wherein
the positive electrode active material layer further includes a third thick part positioned on an opposite side of the first thin part to the winding center side edge of the positive electrode active material layer in the longitudinal direction, and
the third thick part has a thickness greater than the thickness of the first thin part.

5. The secondary battery according to claim 1, wherein
the positive electrode current collector includes an inward surface and an outward surface, the inward surface facing toward a winding center side of the electrode wound body, the outward surface facing toward an outer side opposite to the winding center side of the electrode wound body, and
each of the first thick part and the first thin part is provided on each of the inward surface and the outward surface of the positive electrode current collector.

6. The secondary battery according to claim 4, wherein
the positive electrode current collector includes an inward surface and an outward surface, the inward surface facing toward a winding center side of the electrode wound body, the outward surface facing toward an outer side opposite to the winding center side of the electrode wound body,
the positive electrode active material layer includes a first positive electrode active material layer and a second positive electrode active material layer, the first positive electrode active material layer being provided on the inward surface of the positive electrode current collector, the second positive electrode active material layer being provided on the outward surface of the positive electrode current collector,
each of the first positive electrode active material layer and the second positive electrode active material layer includes the first thin part, the first thick part, and the third thick part, and
a first length and a second length are different from each other, the first length being a length from the winding center side edge of the positive electrode active material layer in the longitudinal direction to a position of a first border between the first thin part of the first positive electrode active material layer and the third thick part of the first positive electrode active material layer, the second length being a length from the winding center side edge of the positive electrode active material layer in the longitudinal direction to a position of a second border between the first thin part of the second positive electrode active material layer and the third thick part of the second positive electrode active material layer.

7. The secondary battery according to claim 4, wherein the positive electrode active material layer further includes a grooved part between the third thick part and the first thin part.

8. The secondary battery according to claim 4, wherein
the positive electrode active material layer further includes a second thin part on an opposite side of the third thick part to the first thin part, and
the second thin part has a thickness smaller than the thickness of the third thick part.

9. A battery pack comprising:
a secondary battery;
a processor configured to control the secondary battery; and
an outer package body containing the secondary battery,
the secondary battery including
an electrode wound body including a stacked body and having a through hole, the stacked body including a positive electrode, a negative electrode, and a separator and being wound along a longitudinal direction of the stacked body, the through hole being provided through the electrode wound body in a width direction orthogonal to the longitudinal direction, and
an outer package can containing the electrode wound body, wherein
the positive electrode includes
a positive electrode active material layer extending in both the longitudinal direction and the width direction, and
a positive electrode current collector including a positive electrode covered region and a positive electrode exposed region, the positive electrode covered region being covered with the positive electrode active material layer, the positive electrode exposed region being covered with no positive electrode active material layer and extending in the width direction from the positive electrode active material layer, and
the positive electrode active material layer includes a first thin part and a first thick part, the first thick part having a thickness greater than a thickness of the first thin part and being adjacent to the first thin part in the width direction.
